(19) United States
(12) Patent Application Publication
(10) Pub. No.: US 2026/0246515 A1
(43) Pub. Date: Aug. 20, 2026

(54) MULTI-RESOLUTION PRECODING BASED ON MULTIPLE SUBMATRICES

(71) Applicant: Lenovo (Singapore) Pte. Limited, Singapore (SG)

(72) Inventors: Ahmed Hindy, Aurora, IL (US); Venkata Srinivas Kothapalli, Aurora, IL (US); Vahid Pourahmadi, München (DE); Vijay Nangia, Woodridge, IL (US)

(73) Assignee: Lenovo (Singapore) Pte. Limited, Singapore (SG)

(21) Appl. No.: 19/157,030

(22) PCT Filed: Jan. 19, 2024
(86) PCT No.: PCT/IB2024/050540

§ 371 Date: Aug. 15, 2025

Related U.S. Application Data
(60) Provisional application No. 63/446,606, filed on Feb. 17, 2023.

(51) Int. Cl. H04B 7/06; H04B 7/0456

(52) U.S. Cl. CPC H04B 7/0626; H04B 7/0479; H04B 7/0632

(57) ABSTRACT

Various aspects of the present disclosure relate to multi-resolution precoding based on multiple submatrices. A user equipment (UE) receives, from a network entity, a set of channel measurement reference signalings including at least one non-zero power (NZP) CSI reference signal (CSI-RS) resource. The UE generates, based on the at least one NZP CSI-RS resource and a precoding matrix, a CSI report and transmits the CSI report to the network entity. The precoding matrix used by the UE is a Kronecker product of two submatrices, with a first of the two submatrices corresponding to a low-resolution precoding and the Kronecker product of the two submatrices corresponding to a high-resolution precoding. Accordingly, the UE uses the first submatrix to generate the CSI report when a low-resolution CSI report is desired or requested, and uses the Kronecker product of the first and second matrices when a high-resolution CSI report is desired or requested.

### RELATED APPLICATION

This application claims priority to U.S. Patent Application Ser. No. 63/446,606 filed Feb. 17, 2023 entitled “MULTI-RESOLUTION PRECODING BASED ON MULTIPLE SUBMATRICES,” the disclosure of which is incorporated by reference herein in its entirety.

### TECHNICAL FIELD

The present disclosure relates to wireless communications, and more specifically to multi-resolution precoding based on multiple submatrices.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, channel state information (CSI) feedback can be transmitted from one device to another, such as from a UE to a base station (e.g., a gNB) or from a base station (e.g., a gNB) to a UE. The CSI feedback provides the receiving device with an indication of the quality of a channel at a particular time.

### SUMMARY

The present disclosure relates to methods, apparatuses, and systems that support multi-resolution precoding based on multiple submatrices. A UE receives, from a network entity (e.g., a gNB), a set of channel measurement reference signalings including at least one non-zero power (NZP) CSI reference signal (CSI-RS) resource. The UE generates, based on the at least one NZP CSI-RS resource and a precoding matrix, a CSI report and transmits the CSI report to the network entity. The precoding matrix used by the UE is a Kronecker product of a first submatrix and a second submatrix, with the first submatrix corresponding to a low-resolution precoding and the Kronecker product of the two submatrices corresponding to a high-resolution precoding. Accordingly, the UE uses the first submatrix to generate the CSI report when a low-resolution CSI report is desired or requested, and uses the Kronecker product of the first and second matrices when a high-resolution CSI report is desired or requested. By using one of the two submatrices or the Kronecker product of the two submatrices to generate the CSI report, the UE is able to quickly adapt to different situations or requests for a low-resolution CSI report or a high-resolution CSI report.

Some implementations of the method and apparatuses described herein may further include to: receive, from a network entity, a first signaling indicating a CSI reporting setting; receive, from the network entity, a set of channel measurement resources comprising at least one NZP CSI-RS resource; generate, based on the at least one NZP CSI-RS resource and the CSI reporting setting, a precoding matrix that is associated with a CSI report, wherein the precoding matrix comprises a Kronecker product of a first submatrix and a second submatrix; transmit, to the network entity, a second signaling indicating the CSI report.

In some implementations of the method and apparatuses described herein, the Kronecker product of the first submatrix and the second submatrix corresponds to a matrix having dimensions that are a product of dimensions of the first submatrix and the second submatrix. Additionally or alternatively, the first submatrix and the second submatrix correspond to different resolutions of the precoding matrix in at least one of spatial domain, beam domain, frequency domain, delay domain, time domain or Doppler domain. Additionally or alternatively, a number of dimensions of the first submatrix is equal to a number of antenna ports of a first antenna group of two antenna port groups, and a number of dimensions of the second submatrix is equal to a number of antenna ports of a second antenna group of the two antenna port groups. Additionally or alternatively, the first antenna group and the second antenna group correspond to at least one of: two sets of CSI-RS port groups; two antenna port groups with horizontal and vertical orientations, respectively; or two sets of spatial beams. Additionally or alternatively, the method and apparatuses may further generate, in a first mode, precoding matrix using the Kronecker product of the first submatrix and the second submatrix, and generate, in a second mode, the precoding matrix using the first submatrix. Additionally or alternatively, the CSI report includes two channel quality indicator (CQI) values, a first CQI value corresponds to the first mode and a second CQI value corresponds to the second mode. Additionally or alternatively, the at least one NZP CSI-RS resource comprises two groups of NZP CSI-RS ports. Additionally or alternatively, at least one of: the two groups of NZP CSI-RS ports correspond to two distinct NZP CSI-RS resources; the two groups of NZP CSI-RS ports are configured with a same time offset value; the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or the two groups of NZP CSI-RS ports are configured with two frequency density values, a first frequency density value corresponding to the first group of NZP CSI-RS ports is an integer multiple of a second frequency density value corresponding to the second group of NZP CSI-RS ports. Additionally or alternatively, the first submatrix comprises a set of pre-defined vectors associated with one or more indicator values, and the second submatrix comprises a set of coefficients, wherein each coefficient of the set of coefficients comprises an amplitude value and a phase value. Additionally or alternatively, the CSI reporting setting configures the apparatus with one of periodic CSI reporting or semi-persistent CSI reporting, the first submatrix and the second submatrix being reported with two periodicity values and a same offset value. Additionally or alternatively, a first periodicity value corresponding to the first submatrix is an integer multiple of a second periodicity value corresponding to the second submatrix. Additionally or alternatively, the set of channel measurement resources comprises multiple NZP CSI-RS resources. Additionally or alternatively, the first submatrix comprises a first set of parameters that are common for the multiple NZP CSI-RS resources, the second submatrix is decomposed into multiple partitions, and each partition of the multiple partitions is associated with each NZP CSI-RS resource of the multiple NZP CSI-RS resources. Additionally or alternatively, the multiple NZP CSI-RS resources are partitioned into two subsets of NZP CSI-RS resources, each NZP CSI-RS resource of a first subset of the NZP CSI-RS resources is associated with a number of NZP CSI-RS ports that is equal to a number of dimensions of the precoding matrix, and each NZP CSI-RS resource of a second subset of the NZP CSI-RS resources is associated with a number of NZP CSI-RS ports that is equal to a number of dimensions of the first submatrix. Additionally or alternatively, the first subset of the NZP CSI-RS resources comprises a single NZP CSI-RS resource, and the second subset of the NZP CSI-RS resources comprises a remainder of NZP CSI-RS resources of the multiple NZP CSI-RS resources. Additionally or alternatively, the CSI report includes a single value of the first submatrix and multiple values of the second submatrix, and each value of the multiple values of the second submatrix is associated with each NZP CSI-RS resource of the multiple NZP CSI-RS resources.

Some implementations of the method and apparatuses described herein may further include to: transmit, to a UE, a first signaling indicating a CSI reporting setting; transmit, to the UE, a set of channel measurement resources comprising at least one NZP CSI-RS resource; receive, from the UE, a second signaling indicating a CSI report associated with a precoding matrix generated based on the at least one NZP CSI-RS resource and the CSI reporting setting, wherein the precoding matrix comprises a Kronecker product of a first submatrix and a second submatrix.

In some implementations of the method and apparatuses described herein, the Kronecker product of the first submatrix and the second submatrix corresponds to a matrix having dimensions that are a product of dimensions of the first submatrix and the second submatrix. Additionally or alternatively, the first submatrix and the second submatrix correspond to different resolutions of the precoding matrix in at least one of spatial domain, beam domain, frequency domain, delay domain, time domain or Doppler domain. Additionally or alternatively, a number of dimensions of the first submatrix is equal to a number of antenna ports of a first antenna group of two antenna port groups, and a number of dimensions of the second submatrix is equal to a number of antenna ports of a second antenna group of the two antenna port groups. Additionally or alternatively, the first antenna group and the second antenna group correspond to at least one of: two sets of CSI-RS port groups; two antenna port groups with horizontal and vertical orientations, respectively; or two sets of spatial beams. Additionally or alternatively, the precoding matrix having been generated, in a first mode, using the Kronecker product of the first submatrix and the second submatrix, and generated, in a second mode, using the first submatrix. Additionally or alternatively, the CSI report includes two CQI values, a first CQI value corresponds to the first mode and a second CQI value corresponds to the second mode. Additionally or alternatively, the at least one NZP CSI-RS resource comprises two groups of NZP CSI-RS ports. Additionally or alternatively, at least one of: the two groups of NZP CSI-RS ports correspond to two distinct NZP CSI-RS resources; the two groups of NZP CSI-RS ports are configured with a same time offset value; the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or the two groups of NZP CSI-RS ports are configured with two frequency density values, a first frequency density value corresponding to the first group of NZP CSI-RS ports is an integer multiple of a second frequency density value corresponding to the second group of NZP CSI-RS ports. Additionally or alternatively, the first submatrix comprises a set of pre-defined vectors associated with one or more indicator values, and the second submatrix comprises a set of coefficients, wherein each coefficient of the set of coefficients comprises an amplitude value and a phase value. Additionally or alternatively, the CSI reporting setting configures the UE with one of periodic CSI reporting or semi-persistent CSI reporting, the first submatrix and the second submatrix being reported with two periodicity values and a same offset value. Additionally or alternatively, a first periodicity value corresponding to the first submatrix is an integer multiple of a second periodicity value corresponding to the second submatrix. Additionally or alternatively, the set of channel measurement resources comprises multiple NZP CSI-RS resources. Additionally or alternatively, the first submatrix comprises a first set of parameters that are common for the multiple NZP CSI-RS resources, the second submatrix is decomposed into multiple partitions, and each partition of the multiple partitions is associated with each NZP CSI-RS resource of the multiple NZP CSI-RS resources. Additionally or alternatively, the multiple NZP CSI-RS resources are partitioned into two subsets of NZP CSI-RS resources, each NZP CSI-RS resource of a first subset of the NZP CSI-RS resources is associated with a number of NZP CSI-RS ports that is equal to a number of dimensions of the precoding matrix, and each NZP CSI-RS resource of a second subset of the NZP CSI-RS resources is associated with a number of NZP CSI-RS ports that is equal to a number of dimensions of the first submatrix. Additionally or alternatively, the first subset of the NZP CSI-RS resources comprises a single NZP CSI-RS resource, and the second subset of the NZP CSI-RS resources comprises a remainder of NZP CSI-RS resources of the multiple NZP CSI-RS resources. Additionally or alternatively, the CSI report includes a single value of the first submatrix and multiple values of the second submatrix, and each value of the multiple values of the second submatrix is associated with each NZP CSI-RS resource of the multiple NZP CSI-RS resources.

### BRIEF DESCRIPTION OF THE DRAWINGS

FIG. 1 illustrates an example of a wireless communications system that supports multi-resolution precoding based on multiple submatrices in accordance with aspects of the present disclosure.

FIG. 2 illustrates an aperiodic trigger state defining a list of CSI report settings.

FIG. 3 illustrates an information element pertaining to CSI reporting.

FIG. 4 illustrates an information element 400 for radio resource control (RRC) configuration for wireless resources.

FIG. 5 illustrates a scenario for partial CSI omission for physical uplink shared channel (PUSCH)-based CSI.

FIG. 6 illustrates an example of ASN-1 code for configuring an NZP-CSI-RS resource set, as related to multi-resolution precoding based on multiple submatrices in accordance with aspects of the present disclosure.

FIG. 7 illustrates an example of tracking reference signal (TRS) configuration, as related to multi-resolution precoding based on multiple submatrices in accordance with aspects of the present disclosure.

FIG. 8 illustrates an example of ASN-1 code for quasi co-located (QCL) information, as related to multi-resolution precoding based on multiple submatrices in accordance with aspects of the present disclosure.

FIG. 9 illustrates an example of ASN-1 code for physical downlink shared channel (PDSCH)-Config information element (IE), as related to multi-resolution precoding based on multiple submatrices in accordance with aspects of the present disclosure.

FIG. 10 illustrates an example of ASN-1 code for demodulation reference signal (DMRS)-DownlinkConfig, as related to multi-resolution precoding based on multiple submatrices in accordance with aspects of the present disclosure.

FIGS. 11A and 11B illustrate an example of DMRS patterns for mapping Type A with front-load DMRS, as related to multi-resolution precoding based on multiple submatrices in accordance with aspects of the present disclosure.

FIG. 12 illustrates an example of an antenna layout, as related to multi-resolution precoding based on multiple submatrices in accordance with aspects of the present disclosure.

FIGS. 13 and 14 illustrate examples of block diagrams of devices that support multi-resolution precoding based on multiple submatrices in accordance with aspects of the present disclosure.

FIGS. 15 through 19 illustrate flowcharts of methods that support multi-resolution precoding based on multiple submatrices in accordance with aspects of the present disclosure.

### DETAILED DESCRIPTION

For 3rd Generation Partnership Project (3GPP) new radio (NR), CSI feedback is reported by the UE to the network, where the CSI feedback can take multiple forms based on the CSI feedback report size, time and frequency granularity. In Release 16, high-resolution CSI feedback report (Type-II) was specified, where the frequency granularity of the CSI feedback can be indirectly parametrized. However, scenarios in which the UE speed is relatively high (e.g., up to 500 kilometers per hour) may arise but current codebook designs for high-resolution precoding do not support such high-speed UEs while maintaining a similar quality of service as is available for low-speed UEs. The techniques discussed herein provide multi-level precoding that supports high-resolution precoding (e.g., for high UE speeds) as well as low-resolution precoding (e.g., for low UE speeds).

A UE receives, from a device (e.g., a network entity such as a gNB), a set of channel measurement reference signalings including at least one NZP CSI-RS resource. The UE generates, based on the at least one NZP CSI-RS resource and a precoding matrix, a CSI report and transmits the CSI report to the device (e.g., the network entity). The precoding matrix used by the UE is a Kronecker product of a first submatrix and a second submatrix that correspond to different resolutions of the precoding matrix in at least one of spatial domain, beam domain, frequency domain, delay domain, time domain or Doppler domain. In one or more implementations, the first submatrix corresponds to a low-resolution precoding and the Kronecker product of the two submatrices corresponding to a high-resolution precoding. Accordingly, the UE uses the first submatrix to generate the CSI report when a low-resolution CSI report is desired or requested, and uses the Kronecker product of the first and second matrices when a high-resolution CSI report is desired or requested.

Legacy codebooks, such as discussed in NR Release 15 or NR Release 16 include different codebook types designed for NR, where each codebook type is associated with a given precoding resolution. A drawback to these legacy codebooks is that the legacy codebook types are based on a fixed compression scheme for space, frequency and time domain bases via Discrete Fourier transform (DFT)-based CSI compression, and a single compression level corresponding to a single resolution is configured by the network.

One solution for situations in which a low-resolution CSI report is desired is CSI omission, where the UE omits half of the precoding matrix coefficients reported over UCI based on available uplink (UL) resources. A drawback to CSI omission is that CSI omission groups the precoder matrix coefficients into two groups only, e.g., coefficients with even-numbered and odd-numbered sub-band indices, or based on a fixed transformation of the frequency domain basis indices. No grouping based on the actual channel coherence over time or frequency domain is utilized.

Having the two submatrices as well as the Kronecker product of the two submatrices as discussed herein resolves these drawbacks to legacy codebooks and CSI omission, with the UE being able to quickly adapt to different scenarios or requests for a low-resolution CSI report or a high-resolution CSI report. For example, the UE can use the first submatrix for precoding in scenarios where a low-resolution CSI report is desired, but switch to using the Kronecker product of the first and second matrices in scenarios where a high-resolution CSI report is desired. The techniques discussed herein free the UE from being limited to a single resolution configured by the network, and allows precoder matrix coefficients to be grouped in various different manners (e.g., based on channel coherence over time or frequency domain).

Aspects of the present disclosure are described in the context of a wireless communications system. Aspects of the present disclosure are further illustrated and described with reference to device diagrams and flowcharts.

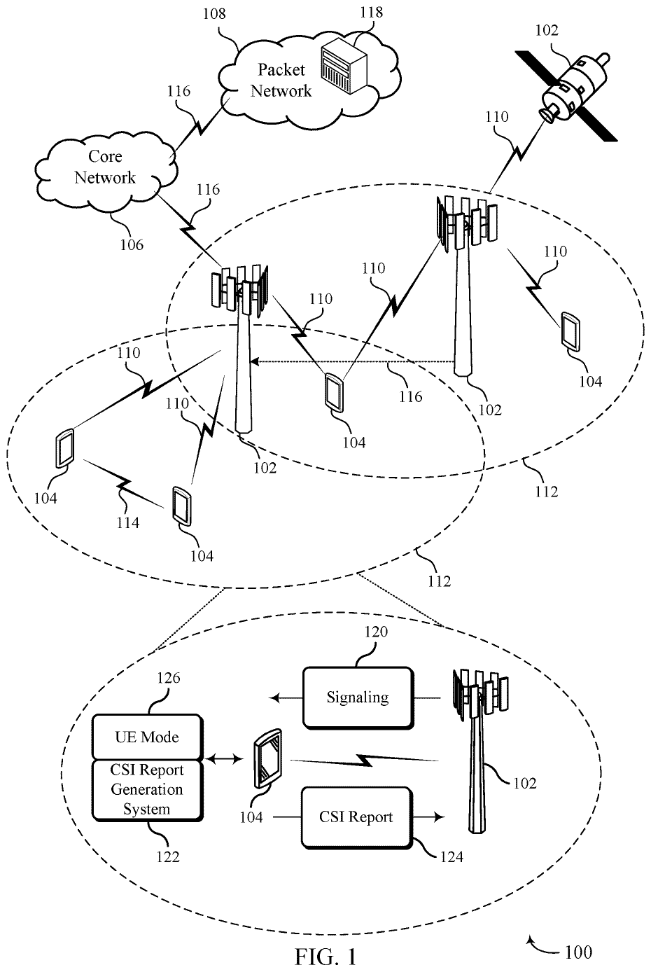

FIG. 1 illustrates an example of a wireless communications system 100 that supports multi-resolution precoding based on multiple submatrices in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), a user plane function (UPF)), or a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The network entity 102 transmits a signaling 120 (e.g., a NZP CSI-RS) to the UE 104. The UE 104 includes a CSI report generation system 122 that generates a CSI report 124, based on a precoding matrix and the signaling 120 as well as a UE mode 126. The precoding matrix is, for example, a Kronecker product of a first submatrix and a second submatrix. In one or more implementations, in one UE mode the CSI report generation system 122 generates the CSI report 124 (e.g., a high resolution CSI report) using the Kronecker product of the first and second submatrices, and in another UE mode the CSI report generation system 122 generates the CSI report 124 (e.g., a low resolution CSI report) using the first submatrix. The UE 104 transmits the generated CSI report 124 to the network entity 102.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of a PDSCH, a physical downlink control channel (PDCCH), a PUSCH, a physical uplink control channel (PUCCH), radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

Various NR codebook types may be used for compression in the spatial and/or frequency domain. In some wireless communications systems, details are provided for NR Type-II codebook. For instance, assume that a gNB is equipped with a two-dimensional (2D) antenna array with N₁, N₂ antenna ports per polarization placed horizontally and vertically and communication occurs over N₃ PMI sub-bands. A PMI subband can consist of a set of resource blocks, each resource block consisting of a set of subcarriers. In such case, 2N₁N₂ Channel State Information (CSI)-Reference Signal (RS) ports can be utilized to enable downlink (DL) channel estimation with high resolution for NR Rel. 15 Type-II codebook. In order to reduce the UL feedback overhead, a DFT-based CSI compression of the spatial domain can be applied to L dimensions per polarization, where L<N₁N₂. In the sequel the indices of the 2L dimensions can be referred as the Spatial Domain (SD) basis indices. The magnitude and phase values of the linear combination coefficients for each sub-band can be fed back to the gNB as part of the CSI report. The 2N₁N₂×N₃ codebook per layer 1 can take on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors can be assumed for the 2D DFT matrix from which matrix B is drawn. Note that W₁ can be common across all layers. W_{2,l} is a 2L×N₃ matrix, where the i^{th} column corresponds to the linear combination coefficients of the 2L beams in the i^{th} sub-band. Only the indices of the L selected columns of B can be reported, along with the oversampling index taking on O₁O₂ values. Note that W_{2,l} can be independent for different layers.

In some wireless communications systems, details are provided for NR Type-II port selection codebook. For instance, for Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {W}_{2 , l} .$$

Here, W₂ may follow the same structure as the conventional NR Rel. 15 Type-II Codebook, and is layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

$$where {e}_{i}^{( K )}$$

is a standard unit vector with a 1 at the i^{th} location. Here d_{PS} is an RRC parameter which takes on the values {1, 2, 3, 4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} areas follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0, 1, 2, 3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0, 1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In some wireless communications systems, details are provided for NR Type-I codebook. For instance, NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, where a phase coupling value is reported for each sub-band, e.g., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁= . . . =φ_{N}_{₃}₋₁, e.g., wideband reporting. For RI>2, different beams are used for each pair of layers. NR Rel. 15 Type-I codebook can be depicted as a low-resolution version of NR Rel. 15 Type-II codebook with spatial beam selection per layer-pair and phase combining only.

In some wireless communications systems, details are provided for NR Rel. 16 Type-I codebook. For instance, assume that a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such cases, 2N₁N₂N₃ CSI-RS ports can be utilized to enable DL channel estimation with high resolution for NR Rel. 16 Type-II codebook. In order to reduce the UL feedback overhead, a Discrete Fourier transform (DFT)-based CSI compression of the spatial domain can be applied to L dimensions per polarization, where L<N₁N₂. Similarly, additional compression in the frequency domain can be applied, where each beam of the frequency-domain precoding vectors is transformed using an inverse DFT matrix to the delay domain, and the magnitude and phase values of a subset of the delay-domain coefficients can be selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ]\end{matrix} ,$$

$${l}_{i} = {O}_{1} {n}_{1}^{( i )} + {q}_{1} , 0 \leq {n}_{1}^{( i )} < {N}_{1} , 0 \leq {q}_{1} < {0}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {0}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N3×M matrix (M<N₃) with columns selected from a critically-sampled size-N₃ DFT matrix, as follows

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} \leq {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

In some scenarios the indices of the L selected columns of B are reported, along with the oversampling index taking on O₁O₂ values. Similarly, for W_{f,l}, the indices of the M selected columns out of the predefined size-N₃ DFT matrix are reported. In the sequel the indices of the M dimensions can be referred as the selected Frequency Domain (FD) basis indices. Hence, L, M represent the equivalent spatial and frequency dimensions after compression, respectively. Further, the 2L×M matrix \tilde{W}₂ represents the linear combination coefficients (LCCs) of the spatial and frequency DFT-basis vectors. Both \tilde{W}₂, W_{f} can be selected independent for different layers. Amplitude and phase values of an approximately. β fraction of the 2LM available coefficients are reported to the gNB (β<1) as part of the CSI report. Note that coefficients with zero amplitude values are indicated via a layer-specific bitmap with the strongest coefficient amplitude set to one, and an index of the strongest coefficient reported. No amplitude or phase information is explicitly reported for this coefficient. Amplitude and phase values of a maximum of ┌2βLM┐−1 coefficients, compared with 2N₁N₂×N₃−1 coefficients' information.

For NR Rel. 16 Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,l} and W_{3,l} follow the same structure as the conventional NR Rel. 16 Type-II Codebook, where both are layer specific. The matrix

$${W}_{1}^{PS}$$

can be a K×2L block-diagonal matrix with the same structure as that in the NR Rel. 15 Type-II Port Selection Codebook.

The NR Rel. 17 Type-II Port Selection codebook can follow a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, \tilde{W}_{2,l} and W_{f,l} follow the same structure as the conventional NR Rel. 16 Type-II Codebook, however M can be limited to 1, 2 only, with the network configuring a window of size N={2, 4} for M=2. Moreover, the bitmap is reported unless β=1 and the UE reports all the coefficients for a rank up to a value of two.

In some scenarios a codebook report is partitioned into two parts based on the priority of information reported. Each part is encoded separately (Part 1 has a possibly higher code rate). A list is presented below the parameters for NR Rel. 16 Type-II codebook.

For content of a CSI report:
Part 1: RI+CQI+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can be implemented to allow dynamic reporting size for codebook based on available resources in the uplink phase. Also Type-II codebook can be based on aperiodic CSI reporting, and reported in PUSCH via DCI triggering (with at least one exception). Type-I codebook can be based on periodic CSI reporting (PUCCH) or semi-persistent CSI reporting (PUSCH or PUCCH) or aperiodic reporting (PUSCH).

For priority reporting for Part 2 CSI, multiple CSI reports may be transmitted with different priorities, as shown in Table 1 below. Note that the priority of the N_{Rep} CSI reports can be based on the following:
1. A CSI report corresponding to one CSI reporting configuration for one cell may have higher priority compared with another CSI report corresponding to one other CSI reporting configuration for the same cell
2. CSI reports intended to one cell may have higher priority compared with other CSI reports intended to another cell
3. CSI reports may have higher priority based on the CSI report content, e.g., CSI reports carrying L1—Reference Signal Received Power (RSRP) information have higher priority
4. CSI reports may have higher priority based on their type, e.g., whether the CSI report is aperiodic, semi-persistent or periodic, and whether the report is sent via PUSCH or PUCCH, may impact the priority of the CSI report

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Accordingly, CSI reports may be prioritized as follows, where CSI reports with lower identifiers (IDs) have higher priority

$$P r {i}_{iCSI} ( y , k , c , s ) = 2 \cdot {N}_{c e l l s} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1—Signal-to-Interference-and-Noise Ratio (SINR), 1 otherwise
y: 0 for aperiodic reports, 1 for semi-persistent reports on PUSCH, 2 for semi-persistent reports on PUCCH, 3 for periodic reports.

In some scenarios, for triggering aperiodic CSI reporting on PUSCH, a UE can report CSI information for the network using the CSI framework in NR Release 15. The triggering mechanism between a report setting and a resource setting can be summarized in Table 2 below.

TABLE 2
Triggering mechanism between a report
setting and a resource setting

| | | | | AP CSI |
|---|---|---|---|---|
| | | Periodic CSI | SP CSI | Report- |
| | | reporting | reporting | ing |
| Time Domain | Periodic | RRC | MAC control | DCI |
| Behavior of | CSI-RS | configured | element (CE) | |
| Resource | | | (PUCCH) | |
| Setting | | | DCI (PUSCH) | |
| | SP CSI-RS | Not Supported | MAC CE | DCI |
| | | | (PUCCH) | |
| | | | DCI (PUSCH) | |
| | AP CSI-RS | Not Supported | Not Supported | DCI |

Further, in some scenarios:
Associated Resource Settings for a CSI Report Setting have same time domain behavior.
Periodic CSI-RS/Interference Management (IM) resource and CSI reports can be assumed to be present and active once configured by RRC
Aperiodic and semi-persistent CSI-RS/IM resources and CSI reports can be explicitly triggered or activated.
For aperiodic CSI-RS/IM resources and aperiodic CSI reports, the triggering can be done jointly by transmitting a DCI Format 0-1.
Semi-persistent CSI-RS/IM resources and semi-persistent CSI reports can be independently activated.

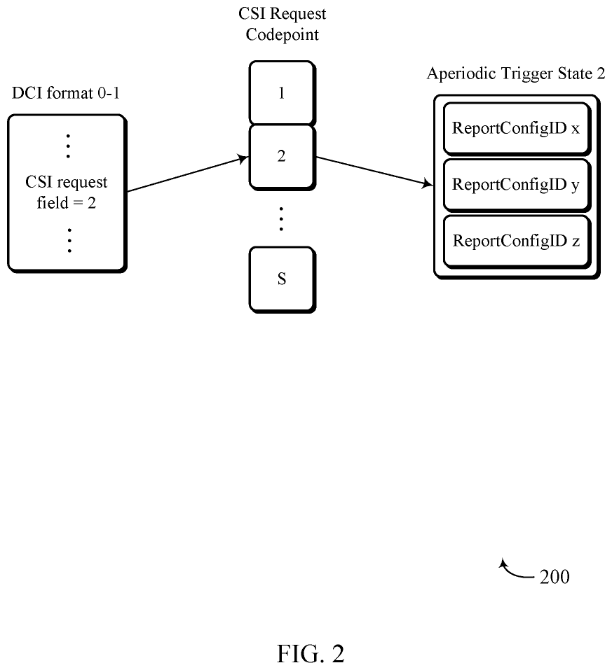

FIG. 2 illustrates an aperiodic trigger state 200 defining a list of CSI report settings. For instance, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC, such as illustrated in FIG. 2. An aperiodic trigger state in turn is defined as a list of up to 16 aperiodic CSI Report Settings, identified by a CSI Report Setting identifier (ID) for which the UE calculates simultaneously CSI and transmits it on the scheduled PUSCH transmission.

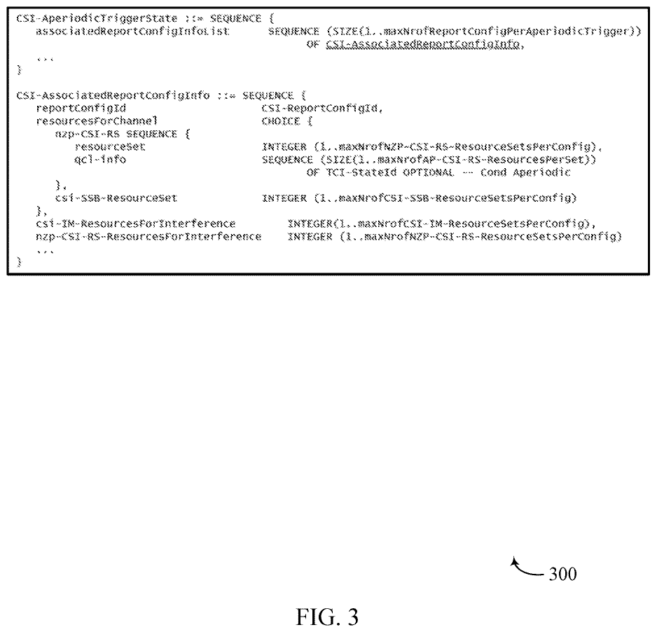

FIG. 3 illustrates an information element 300 pertaining to CSI reporting. The aperiodic trigger state indicates the resource set and QCL information. For instance, when the CSI Report Setting is linked with aperiodic Resource Setting (e.g., including multiple Resource Sets), the aperiodic non-zero power (NZP) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE considers that the resources used for the computation of the channel and interference can be processed with the same spatial filter e.g. quasi-co-located with respect to “QCL-TypeD.”

FIG. 4 illustrates an information element 400 for RRC configuration for wireless resources. The information element 400, for instance, can configure NZP-CSI-RS/CSI-IM resources. The information element 400, for instance, illustrates RRC configuration (a) for NZP-CSI-RS Resource and (b) for CSI-IM-Resource.

Table 3 summarizes the type of uplink channels used for CSI reporting as a function of the CSI codebook type.

TABLE 3
Uplink channels used for CSI reporting
as a function of the CSI codebook type

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
RI (if reported), CSI-RS Resource Index (CRI) (if reported) and CQI for the first codeword,
number of non-zero wideband amplitude coefficients per layer for Type II CSI feedback on PUSCH.

CSI Part 2 has a variable payload size that can be derived from the CSI parameters in CSI Part 1 and contains PMI and the CQI for the second codeword when RI>4.

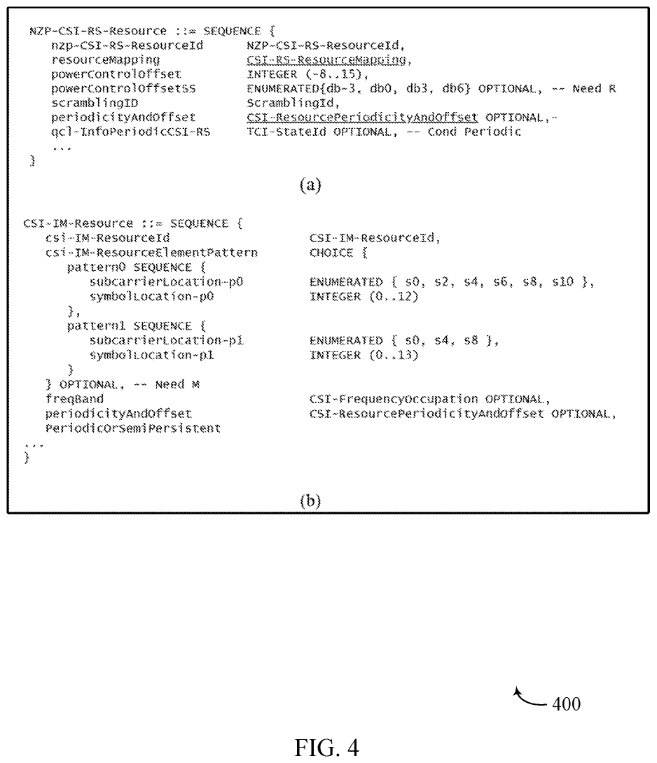

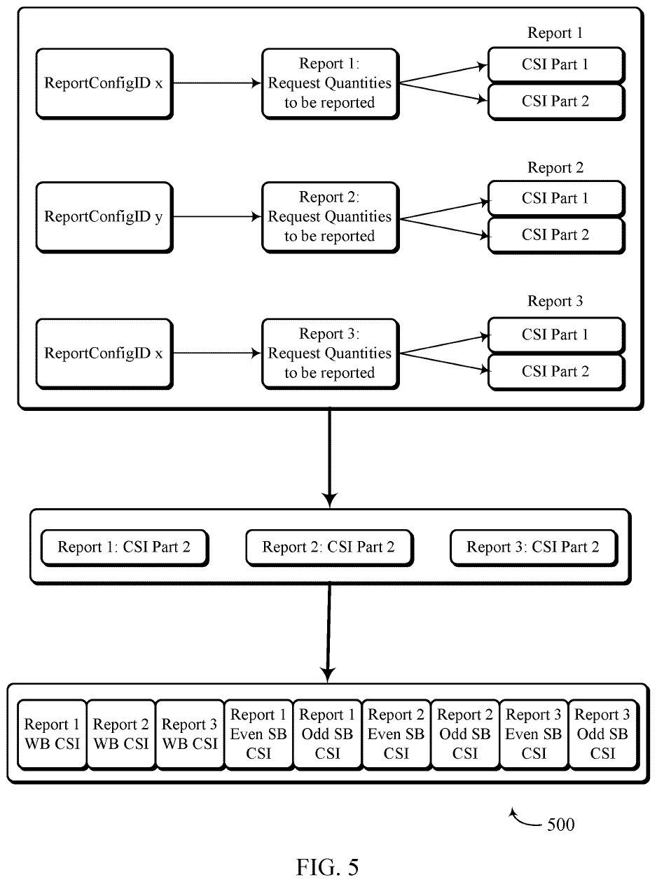

FIG. 5 illustrates a scenario 500 for partial CSI omission for PUSCH-based CSI. The scenario 500, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 can be ordered as illustrated in the scenario 500.

As mentioned above, CSI reports can be prioritized according to:
1. time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. the serving cell to which the CSI corresponds (in case of carrier aggregation (CA) operation). CSI corresponding to the PCell has priority over CSI corresponding to Scells.
4. the reportConfigID.

A CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4, as follows

TABLE 4
Example of a 4-bit CQI table

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, where one CQI value is reported corresponding to each PDSCH transport block, and a subband format, where one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5, as follows:

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6, as follows:

TABLE 6
Mapping subband differential CQI value to offset level

| Sub-band differential CQI | |
|---|---|
| value | Offset level |
| 0 | 0 |
| 1 | 1 |
| 2 | ≥2 |
| 3 | ≤−1 |

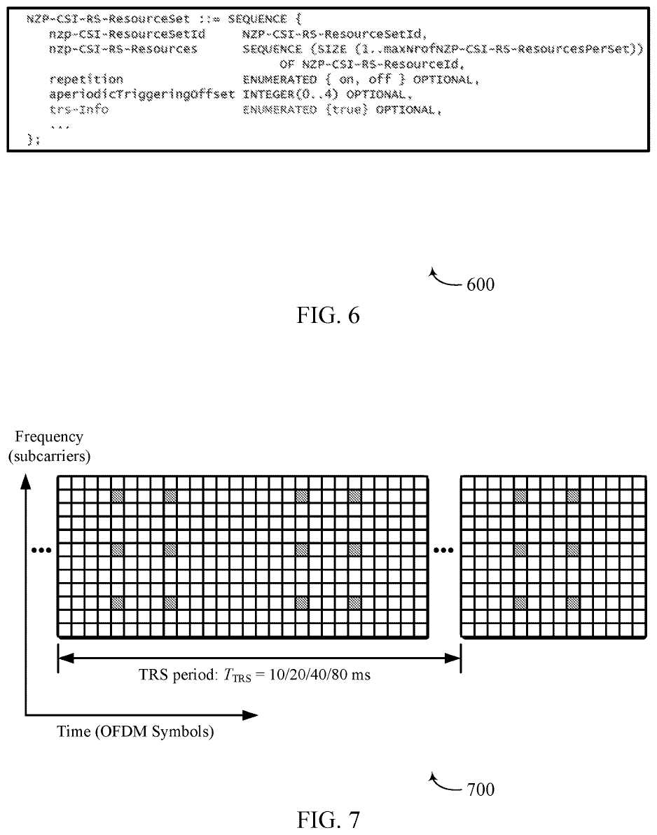

FIG. 6 illustrates an example 600 of ASN-1 code for configuring an NZP-CSI-RS resource set, as related to multi-resolution precoding based on multiple submatrices in accordance with aspects of the present disclosure. Aspects of multi-resolution precoding based on multiple submatrices include and/or are directed to TRS, which is transmitted for establishing fine time and frequency synchronization at a UE to aid in demodulation of PDSCH, particularly for higher order modulations. A TRS is an NZP CSI-RS resource set with “TRS-info” set to true. As shown in the example 600, “trs-info” indicates that the antenna port for all NZP-CSI-RS resources in the CSI-RS resource set is the same. The TRS contains either 2 or 4 periodic CSI-RS resources with periodicity 2^{-μ}*Xp slots where Xp=10, 20, 40, or 80 and where μ is related to the sub carrier spacing (SCS), i.e. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 7.

FIG. 7 illustrates an example 700 of TRS configuration, as related to multi-resolution precoding based on multiple submatrices in accordance with aspects of the present disclosure. In this example 700, the two CSI-RS within a slot are always separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set (1 to 8). The maximum number of TRS resource sets configured to UE per CC: Candidate value set: (1 to 64). The UE is mandated to report at least 8 for FR1 and 16 for FR2. The maximum number of TRS resource sets configured to UE across CCs: Candidate value set: (1 to 256). UE is mandated to report at least 16 for FR1 and 32 for FR2. Furthermore, an aperiodic TRS is a set of aperiodic CSI-RS for tracking that is optionally configured, but a periodic TRS always needs to be configured, and its time and frequency domain configurations (except for the periodicity) must match those of the periodic TRS. The UE may assume that the aperiodic TRS resources are quasi-co-located with the periodic TRS resources.

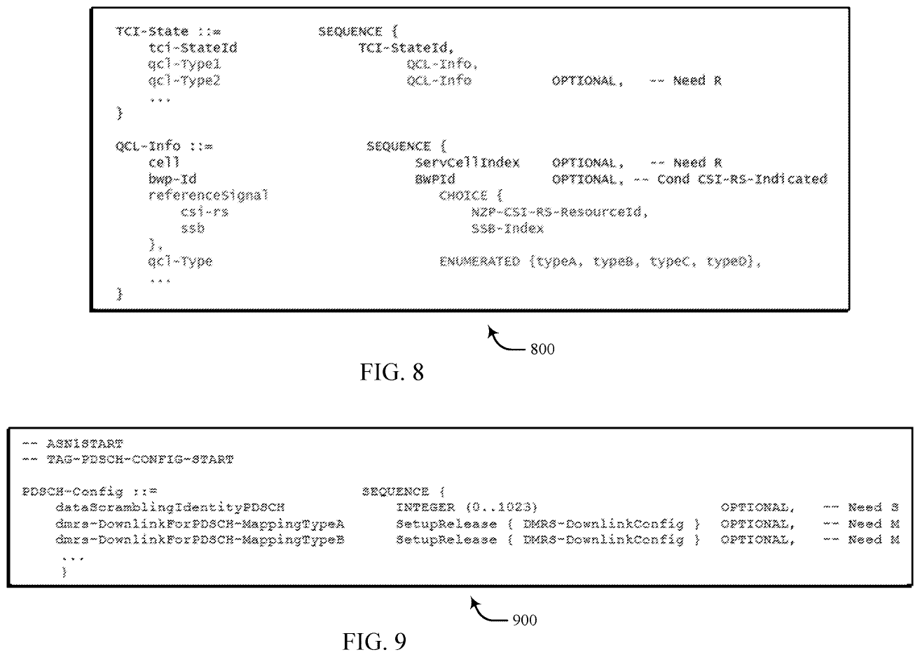

FIG. 8 illustrates an example 800 of ASN-1 code for QCL information, as related to multi-resolution precoding based on multiple submatrices in accordance with aspects of the present disclosure. In this example 800, a transmission configuration indicator (TCI) state (in example 800 and as configured by RRC) will have two QCL types (i.e., two reference signals) with the second QCL type only for operation in FR2.

With reference to DMRS and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a synchronization signal block (SSB) block. The DMRS is used to estimate channel coefficients for coherent detection of the physical channels. For downlink, the DMRS is subject to the same precoding as the PDSCH. NR first defines two time-domain structures for DMRS according to the location of the first DM-RS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the code-division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

FIG. 9 illustrates an example 900 of ASN-1 code for PDSCH-Config IE, as related to multi-resolution precoding based on multiple submatrices in accordance with aspects of the present disclosure. In this example 900, note that the configuration of the DMRS Type is provided through higher-layer signaling independently for each PDSCH and PUSCH, each mapping Type (A or B), and each BWP independently (see the RRC configuration). The PDSCH-Config Information Element (IE), as shown in example 900, is used to configure the UE specific PDSCH parameters.

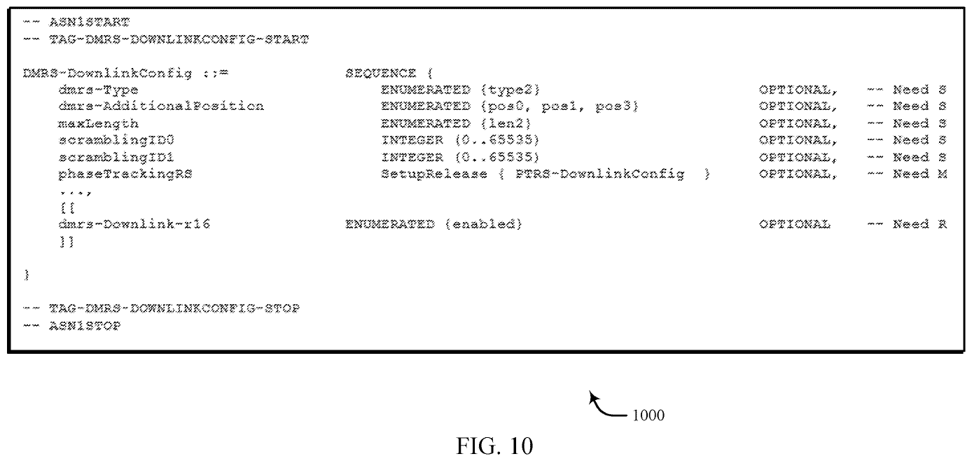

FIG. 10 illustrates an example 1000 of ASN-1 code for DMRS-DownlinkConfig, as related to multi-resolution precoding based on multiple submatrices in accordance with aspects of the present disclosure. In this example 1000, the IE DMRS-DownlinkConfig is used to configure downlink demodulation reference signals for PDSCH.

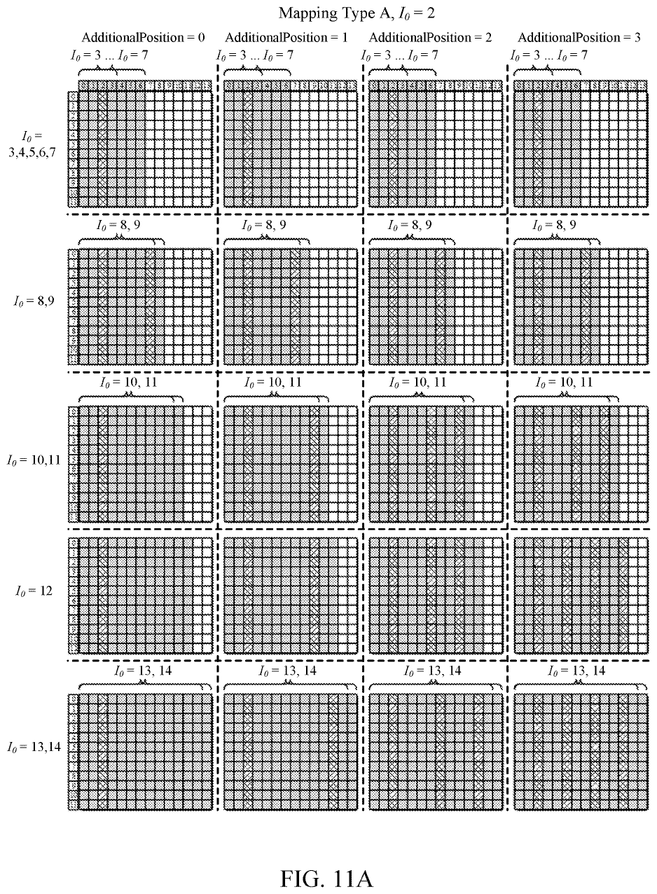

FIGS. 11A and 11B illustrate an example 1100 of DMRS patterns for mapping Type A with front-load DMRS, as related to multi-resolution precoding based on multiple submatrices in accordance with aspects of the present disclosure. In this example 1100, the time domain mapping of the DMRS patterns can be decomposed to two parts. For example the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to 4 DMRS symbols. The location of the DMRS is defined by both higher-layer configuration and dynamic (DCI-based) signaling, such as dmrs-TypeA-Position, maxLength, and dmrs-AdditionalPosition. When double-symbol DMRS is used, there can be up to one more double-symbol DMRS (total 4 DMRS symbols inside the PDSCH allocation). Different DMRS patterns for mapping Type A with front-load DM-RS are shown in the example 1100.

In the absence of CSI-RS configuration, and unless otherwise configured, the UE may assume PDSCH DMRS and SS/physical broadcast channel (PBCH) block antenna ports are quasi co-located with respect to Doppler shift, Doppler spread, average delay, delay spread, and spatial Rx parameters (if applicable). However, a CSI-RS for tracking can be used as a QCL reference (e.g., having larger bandwidth than an SS/PBCH block). Furthermore, the UE may assume that the PDSCH DMRS within the same CDM group are quasi co-located with respect to Doppler shift, Doppler spread, average delay, delay spread, and spatial Rx. The UE may then perform a joint estimation of DMRS ports which are CDMed using the same long-term statistics, and it is not required to measure, or use, different long-term statistics for different DMRS ports of the same PDSCH.

The techniques discussed herein may use Kronecker product decomposition. The following notation is used for Kronecker product decomposition. For a matrix Z∈ [symbol] ^{r×t}, zᵢⱼ, Z_{i,1:t}, Z_{1:r,j} denote (i, j)^{th} element, i^{th} row, j^{th} column of matrix Z, respectively. A block of matrix Z consisting of elements in row i to i′ and column j to j′ and is denoted by Z_{i:i′,j:j′}. Superscript T denotes transpose and superscript * denotes conjugate transpose (also known as Hermitian transpose) of a vector or a matrix.

Consider matrix A and matrix B having real-valued elements with dimensions r₁×t₁ and r₂×t₂, respectively, which implies that A∈ [symbol] ^{r}^{₁}^{×t}^{₁}, B∈ [symbol] ^{r}^{₂}^{×t}^{₂} in formal mathematical notation. The Kronecker product of A and B, denoted by A⊗B, is defined as follows:

$$A ⊗ B = C = [ \begin{matrix}{a}_{11} B & … & {a}_{1 {t}_{1}} B \\ ⋮ & ⋱ & ⋮ \\ {a}_{{r}_{1} 1} B & … & {a}_{{r}_{1} {t}_{1}} B\end{matrix} ] ∈ {ℝ}^{{r}_{1} {r}_{2} \times {t}_{1} {t}_{2}}$$

In a Kronecker product decomposition, two lower-dimensional matrices construct a higher dimensional matrix. In the equation above, matrices A and B may be called Kronecker factor matrices, or submatrices, of matrix C. To summarize, the Kronecker Product Decomposition finds (lower-dimensional) Kronecker factor matrices for a given matrix (of higher dimensions).

Aspects of reference signal enhancements for network energy savings (NES) include and/or are directed to antenna panels and/or ports, quasi-collocation, TCI state, and spatial relation. In implementations described herein, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel includes an array of antenna elements, where each antenna element is connected to hardware, such as a phase shifter that allows a control module to apply spatial parameters for transmission and/or reception of signals. The resulting radiation pattern is called a beam, which may or may not be unimodal and allows the device to amplify signals that are transmitted or received from spatial directions.

In one or more implementations, an antenna panel may be virtualized as an antenna port in the specifications. An antenna panel can be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information is communicated via signaling or, in some implementations, capability information is provided to devices without a need for signaling. In the event that such information is available to other devices, it can be used for signaling or local decision making.

In one or more implementations, a device (e.g., a UE, a network node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel (or device panel) may be a logical entity with physical device antennas mapped to the logical entity. The mapping of physical device antennas to the logical entity can be based on device implementation. Communicating (e.g., receiving or transmitting) on at least a subset of antenna elements or antenna ports active for radiating energy (also referred to herein as active elements) of an antenna panel requires biasing or powering of the RF chain, which results in current drain or power consumption in the device associated with the antenna panel, including power amplifier and/or low noise amplifier (LNA) power consumption associated with the antenna elements or antenna ports. The phrase “active for radiating energy,” as used herein is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, and depending on the particular device implementation, a device panel can have at least one of the following functionalities as an operational role: a unit of an antenna group to control its transmit beam independently, a unit of an antenna group to control its transmission power independently, and/or a unit of an antenna group to control its transmission timing independently. The device panel may be transparent to a gNB. For certain condition(s), a gNB or a network node can assume the mapping between the physical antennas of a device to the logical entity “device panel” may not be changed. For example, the condition may include until the next update or report from a device, or include a duration of time over which the gNB assumes there will be no change to the mapping. A device may report its capability with respect to the device panel to the gNB or network. The device capability can include at least the number of device panels. In an implementation, the device may support UL transmission from one beam within a panel, and with multiple panels, more than one beam (e.g., one beam per panel) may be used for UL transmission. In another implementation, more than one beam per panel may be supported or used for UL transmission.

In some described implementations, an antenna port is defined such that the channel over which a symbol on the antenna port is conveyed can be inferred from the channel over which another symbol on the same antenna port is conveyed. Two antenna ports are quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and/or spatial receive parameters. Two antenna ports may be quasi-located with respect to a subset of the large-scale properties, and a different subset of large-scale properties can be indicated by a QCL type. The QCL type can indicate which channel properties are the same between the two reference signals (e.g., on the two antenna ports). Thus, the reference signals can be linked to each other with respect to what the UE can assume about their channel statistics or QCL properties. For example, the QCL-type can be one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

Spatial receive parameters can include one or more of angle of arrival (AoA) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same receive (RX) beamforming weights).

As described in this disclosure, an antenna port may be a logical port that corresponds to a beam (resulting from beamforming), or may correspond to a physical antenna on a device. In one or more implementations, a physical antenna can map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., a target RS of DM-RS ports of the target transmission during a transmission occasion) and one or more source reference signals (e.g., SSB, CSI-RS, and/or sounding reference signal (SRS)) with respect to quasi co-location type parameters indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the described implementations, a TCI state includes at least one source RS to provide a reference (UE assumption) for determining QCL and/or a spatial filter.

In one or more implementations, spatial relation information associated with a target transmission can indicate parameters for configuring a spatial setting between the target transmission and a reference RS (e.g., SSB, CSI-RS, and/or SRS). For example, the device can transmit the target transmission with the same spatial domain filter used for reception of the reference RS (e.g., DL RS such as SSB or CSI-RS). In another example, the device may transmit the target transmission with the same spatial domain transmission filter used for the transmission of the reference RS (e.g., UL RS, such as SRS). A device can receive a configuration of multiple spatial relation information configurations for a serving cell for transmissions on the serving cell.

In some described implementations, an UL TCI state is provided if a device is configured with separate DL/UL TCI by RRC signaling. The UL TCI state can include a source reference signal which provides a reference for determining an UL spatial domain transmission filter for the UL transmission (e.g., dynamic-grant or configured-grant based PUSCH, dedicated PUCCH resources) in a CC, or across a set of configured CCs and/or BWPs.

In some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated PDCCH and/or PDSCH) and is used to determine UL spatial transmission filter (e.g., for UE-dedicated PUSCH and/or PUCCH) for a CC, or across a set of configured CCs and/or BWPs. In an example, the UL spatial transmission filter is derived from the RS of DL QCL Type-D in the joint TCI state. The spatial setting of the UL transmission may be according to the spatial relation with a reference to the source RS configured with qcl-Type set to “typed” in the joint TCI state.

It should be noted that in the discussions herein, the following notions are used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a TCI state from a transmission configuration including at least two TCI states.

With the techniques discussed herein, the codebook type used for PMI reporting is arbitrary. Different codebook types may be used, such as Type-II Rel. 16 codebook, Type-II Rel. 17 codebook, Type-II Rel. 18 codebook, and so forth.

In one or more implementations, a TRS as discussed herein corresponds to an NZP CSI-RS resource set with a parameter ‘trs-info’ being configured.

In one or more implementations, a CSI-RS for beam management as discussed herein corresponds to an NZP CSI-RS resource set with a parameter ‘repetition’ being configured.

In one or more implementations, a CSI-RS for CSI as discussed herein corresponds to an NZP CSI-RS resource set with neither parameters ‘trs-info’ nor ‘repetition’ being configured.

It should be noted that an order of two submatrices corresponding to Kronecker product decomposition is arbitrary. E.g., a role of a first submatrix and a second submatrix can be interchanged.

It should also be noted that a matrix implies a sequence of fields of an arbitrary dimension, including an array (vector) of values, a standard 2-dimensional (2D) matrix and more generally a Q-dimensional matrix (tensor) where Q≥2 is an integer value.

Several implementations are described below. One or more elements or features from one or more of the described implementations may be combined.

With respect to a Kronecker-based precoding matrix or PMI framework, a precoding matrix corresponding to a PMI codebook is based on a Kronecker product of two submatrices, which may be referred to as PMI submatrices.

In one or more implementations, a first submatrix of the two submatrices (e.g., PMI submatrices) comprises coefficients corresponding to the precoding matrix with respect to first resolution of at least one of spatial domain, frequency domain or time domain, and a second submatrix of the two submatrices (e.g., PMI submatrices) comprises coefficients corresponding to an extension of the precoding matrix with respect to the first submatrix in a form of an extended resolution of at least one of spatial domain, beam domain, frequency domain, delay domain, time domain or Doppler domain. In one example, the second submatrix comprises coefficients corresponding to an extension of the precoding matrix with respect to the first submatrix in a form of an extended resolution of the spatial domain. In another example, the second submatrix comprises coefficients corresponding to an extension of the precoding matrix with respect to the first submatrix in a form of an extended resolution of a combination of the frequency domain and the time domain.

Additionally or alternatively, a first submatrix of the two submatrices (e.g., PMI submatrices) comprises coefficients corresponding to a common precoding matrix with respect to a set of network nodes, and a second submatrix of the two submatrices (e.g., PMI submatrices) comprises coefficients corresponding to an extension of the precoding matrix with respect to the set of network nodes, where the second submatrix is decomposed into a set of partitions corresponding to the set of network nodes. In one example, a number of network nodes in the set of network nodes is equal to a number of partitions of the set of partitions of the second submatrix. In another example, each network node of the set of network nodes is associated with a distinct partition of the set of partitions of the second submatrix.

In a third implementation, a product of number of rows of the first submatrix and the second submatrix is equal to a number of rows of the precoding matrix, and a product of number of columns of the first submatrix and the second submatrix is equal to a number of columns of the precoding matrix. In one example, each of row indices and column indices of the first and second submatrix represent at least one of a spatial domain basis index, beam index, frequency domain basis index, delay domain basis index, time domain basis index, or Doppler domain basis index. In another example, the first submatrix is a 2D matrix with multiple rows and multiple columns, and the second submatrix is a 1-dimensional (1D) array.

Additionally or alternatively, the Kronecker-based precoding matrix supports two modes, a first mode includes reporting two submatrices, and a second mode comprises reporting only the first submatrix, where the second submatrix is a scalar value that is set to one, e.g., the Kronecker product of the two submatrices is equal to the first submatrix.

Additionally or alternatively, a number of beams, CSI-RS ports or spatial-domain basis indices associated with the Kronecker-based codebook is based on a product of two numbers, e.g., N₁, N₂, associated with two dimensions of an antenna array, e.g., horizontal and vertical antenna ports, and the first submatrix is associated with a first of the two numbers, and the second submatrix is associated with the second dimension.

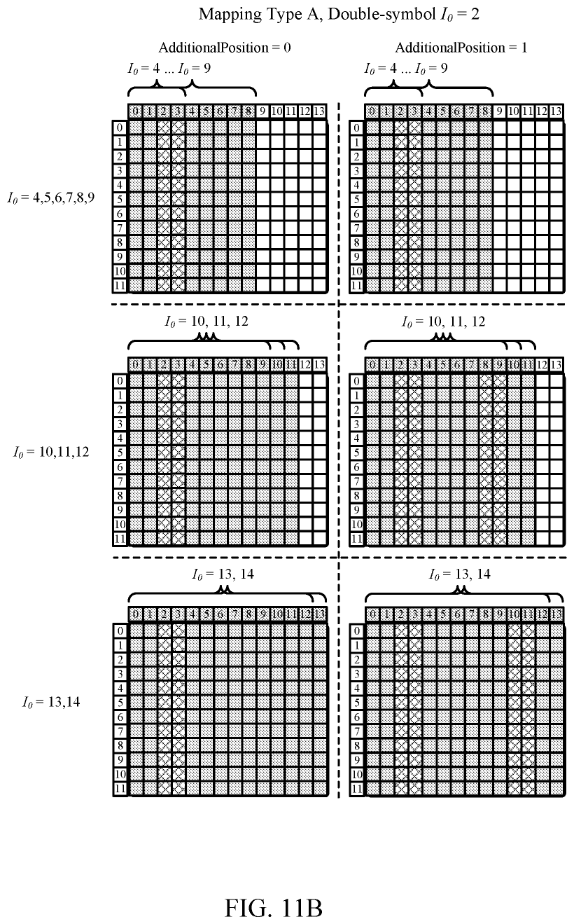

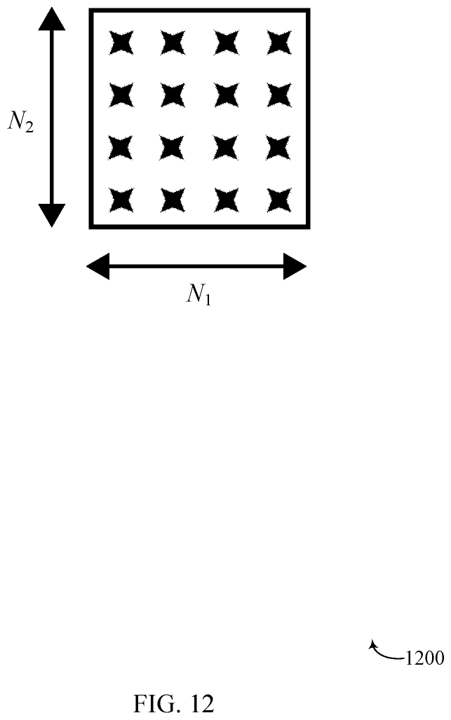

FIG. 12 illustrates an example 1200 of an antenna layout, as related to multi-resolution precoding based on multiple submatrices in accordance with aspects of the present disclosure. The antenna layout in example 1200 has 2N₁N₂ cross-polarized antenna ports, with N₁ and N₂ ports placed horizontally and vertically, respectively.

In one or more implementations, a one submatrix of the two submatrices may be further decomposed into a third submatrix and a fourth submatrix. In one example, the second submatrix is further decomposed into a third submatrix and a fourth submatrix, where a Kronecker product of the third submatrix and the fourth submatrix is equal to the second submatrix.

With respect to Kronecker-based CSI-RS transmission, a group of CSI-RSs are transmitted corresponding to the Kronecker-based PMI codebook.

In one or more implementations, the UE is configured with a single NZP CSI-RS resource associated with channel measurement, where a number of NZP CSI-RS ports of the NZP CSI-RS resource is equal to one of a number of rows or a number of columns of the first submatrix. Or, the number of NZP CSI-RS ports of an NZP CSI-RS resource associated with channel measurement is equal to one of double the number of rows or double the number of columns of the first submatrix.

Additionally or alternatively, the UE is configured with a set of K NZP CSI-RS resources for channel measurement corresponding to K network nodes, where each CSI-RS resource of a first subset of the set of CSI-RS resources is associated with a number of NZP CSI-RS ports that is equal to the number of (or double the number of) rows of the precoding matrix, and each CSI-RS resource of a second subset of the NZP CSI-RS resources is associated with a number of NZP CSI-RS ports that are equal to a number of rows of the first submatrix. In one example, the set of K NZP CSI-RS resources is partitioned into the first and the second subsets of the NZP CSI-RS resources. In another example, the first subset of the NZP CSI-RS resources comprises one NZP CSI-RS resource, and the second subset of the NZP CSI-RS resources comprises K−1 NZP CSI-RS resources.

Additionally or alternatively, the UE is configured with two groups of NZP CSI-RS ports, a first group of NZP CSI-RS ports is transmitted with a first periodicity value and a first frequency density value, and a second group of NZP CSI-RS ports is transmitted with a second periodicity value and a second frequency density value. In one example, the two groups of NZP CSI-RS ports share a same time offset value. In another example, the first periodicity value is an integer multiple of the second periodicity value. In another example, the first frequency density value is a integer multiple of the second frequency density value. In another example, the two groups of NZP CSI-RS ports correspond to two distinct NZP CSI-RS resources of a same NZP CSI-RS resource set. In another example, the two groups of NZP CSI-RS ports correspond to two distinct NZP CSI-RS resources associated with two distinct NZP CSI-RS resource sets.

With respect to Kronecker-based PMI reporting, a Kronecker decomposition matrix corresponds to a PMI codebook with a distinct codebook type, e.g., Type-III codebook.

In one or more implementations, the first submatrix of the two submatrices is associated with a codebook corresponding to a predetermined set of values. In one example, columns of the first submatrix are selected from a set of columns of a transformation matrix, e.g., DFT matrix, corresponding to at least one of spatial domain, frequency domain or time domain. In another example, the first submatrix comprises a set of phase values selected from a codebook of phase values. In another example, the first submatrix comprises a set of amplitude values selected from a codebook of amplitude values. In another example, a codebook including a set of matrices corresponding to the first submatrix are defined, where the UE selects a matrix of the set of matrices corresponding to the first submatrix, and an index of the selected matrix is reported in the corresponding CSI report. In another example, a codebook including a set of vectors corresponding to the first submatrix are defined, where the UE selects a subset of the set of vectors corresponding to the first submatrix, and a group of indices corresponding to the selected subset of vectors are reported in the corresponding CSI report.

Additionally or alternatively, the second submatrix of the two submatrices is based on an element-by-element product of two sets of values drawn from two codebooks, a first codebook corresponding to amplitude values, and a second codebook corresponding to phase values.

Additionally or alternatively, the codebook is associated with a rank indicator, where the CSI feedback comprises a number of layers corresponding to PMI that is equal to a value of the rank indicator.

Additionally or alternatively, a CSI report associated with the codebook comprises two CQI values. In one example, a first of the two CQI values is based on a Type-II codebook or a codebook without Kronecker compression, and a second of the two CQI values is based on a Kronecker compression codebook. In another, a first of the two CQI values is based on one of the two submatrices of the Kronecker-based codebook, and a second of the two CQI values is based on a Kronecker product of the two submatrices of the Kronecker-based codebook

Additionally or alternatively, a CSI report associated with a plurality, e.g., K, of NZP CSI-RS resources comprises a single value of the first submatrix, and a plurality, e.g., K of values of the second submatrix. Alternatively, the CSI report may comprise a plurality, e.g., K, of the first submatrix, and a single value of the second submatrix.

With respect to UCI parameter design for Kronecker-based PMI, the Kronecker-based PMI codebook is reported in the CSI report as part of UCI over one of PUSCH or PUCCH.

In one or more implementations, the CSI report is fed back with aperiodic CSI reporting over PUSCH.

Additionally or alternatively, the CSI report is fed back with periodic CSI reporting over PUCCH, or semi-persistent CSI reporting over PUCCH, PUSCH, or a combination thereof.

Additionally or alternatively, the CSI report is reported with a time-domain behavior that is one of periodic or semi-persistent, where two submatrices are reported with a different periodicity. In one example, the first submatrix is reported with a periodicity that is an integer multiple of a periodicity of the second submatrix. In another example, the two submatrices are reported with a same offset value corresponding to the respective time-domain behavior.

Accordingly, a new codebook design for high-resolution precoding supports two resolutions of the precoding matrix based on a Kronecker-based decomposition of the precoding matrix into two submatrices. In one or more implementations, a codebook design includes a precoding matrix that is decomposed of a Kronecker product of two submatrices, where a first submatrix of the two submatrices corresponds to a low-resolution precoding, and the Kronecker product of the two submatrices corresponds to a high-resolution precoding. An enhanced CSI resource configuration is also discussed where a first set of CSI-RS ports associated with the first submatrix are transmitted with a different configuration compared with a second set of CSI-RS ports associated with the second submatrix. An enhanced CSI reporting mechanism is also discussed where a first part of the CSI feedback associated with the first submatrix is transmitted with a different configuration compared with a second part of the CSI feedback associated with the second submatrix.

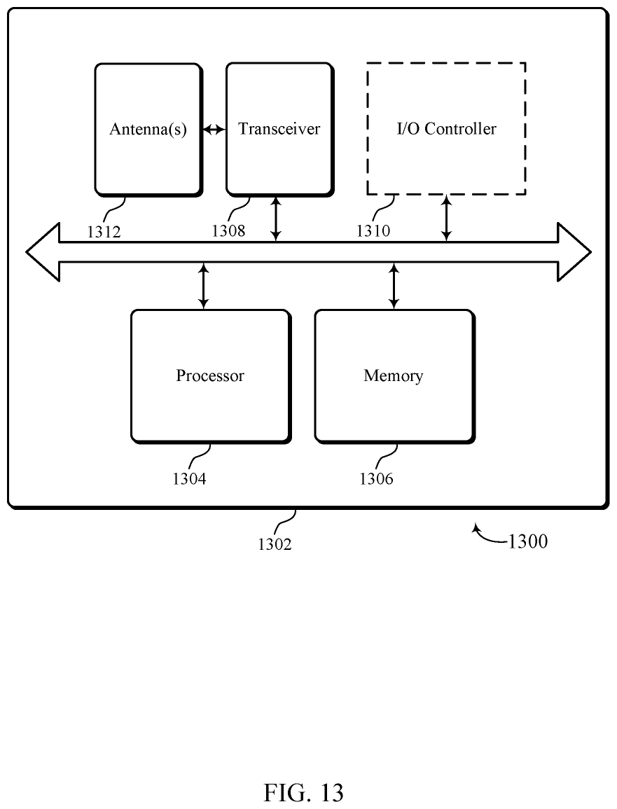

FIG. 13 illustrates an example of a block diagram 1300 of a device 1302 that supports multi-resolution precoding based on multiple submatrices in accordance with aspects of the present disclosure. The device 1302 may be an example of a UE 104 as described herein. The device 1302 may support wireless communication with one or more network entities 102, UEs 104, or any combination thereof. The device 1302 may include components for bi-directional communications including components for transmitting and receiving communications, such as a processor 1304, a memory 1306, a transceiver 1308, and an I/O controller 1310. These components may be in electronic communication or otherwise coupled (e.g., operatively, communicatively, functionally, electronically, electrically) via one or more interfaces (e.g., buses). The device 1302 may also be referred to as an apparatus.

The processor 1304, the memory 1306, the transceiver 1308, or various combinations thereof or various components thereof may be examples of means for performing various aspects of the present disclosure as described herein. For example, the processor 1304, the memory 1306, the transceiver 1308, or various combinations or components thereof may support a method for performing one or more of the operations described herein.

In some implementations, the processor 1304, the memory 1306, the transceiver 1308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1304 and the memory 1306 coupled with the processor 1304 may be configured to perform one or more of the functions described herein (e.g., executing, by the processor 1304, instructions stored in the memory 1306).

For example, the processor 1304 may support wireless communication at the device 1302 in accordance with examples as disclosed herein. Processor 1304 may be configured as or otherwise support to: receive, from a network entity, a first signaling indicating a CSI reporting setting; receive, from the network entity, a set of channel measurement resources including at least one NZP CSI-RS resource; generate, based on the at least one NZP CSI-RS resource and the CSI reporting setting, a precoding matrix that is associated with a CSI report, where the precoding matrix comprises a Kronecker product of a first submatrix and a second submatrix; transmit, to the network entity, a second signaling indicating the CSI report.

Additionally or alternatively, the processor 1304 may be configured to or otherwise support: where the Kronecker product of the first submatrix and the second submatrix corresponds to a matrix having dimensions that are a product of dimensions of the first submatrix and the second submatrix; where the first submatrix and the second submatrix correspond to different resolutions of the precoding matrix in at least one of spatial domain, beam domain, frequency domain, delay domain, time domain or Doppler domain; where a number of dimensions of the first submatrix is equal to a number of antenna ports of a first antenna group of two antenna port groups, and a number of dimensions of the second submatrix is equal to a number of antenna ports of a second antenna group of the two antenna port groups; where the first antenna group and the second antenna group correspond to at least one of: two sets of CSI-RS port groups; two antenna port groups with horizontal and vertical orientations, respectively; or two sets of spatial beams; to generate, in a first mode, the precoding matrix using the Kronecker product of the first submatrix and the second submatrix, and generate, in a second mode, the precoding matrix using the first submatrix; where the CSI report includes two channel quality indicator (CQI) values, a first CQI value corresponds to the first mode and a second CQI value corresponds to the second mode; where the at least one NZP CSI-RS resource comprises two groups of NZP CSI-RS ports; where at least one of: the two groups of NZP CSI-RS ports correspond to two distinct NZP CSI-RS resources; the two groups of NZP CSI-RS ports are configured with a same time offset value; the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or the two groups of NZP CSI-RS ports are configured with two frequency density values, a first frequency density value corresponding to the first group of NZP CSI-RS ports is an integer multiple of a second frequency density value corresponding to the second group of NZP CSI-RS ports; where the first submatrix comprises a set of pre-defined vectors associated with one or more indicator values, and the second submatrix comprises a set of coefficients, where each coefficient of the set of coefficients comprises an amplitude value and a phase value; where the CSI reporting setting configures the apparatus with one of periodic CSI reporting or semi-persistent CSI reporting, the first submatrix and the second submatrix being reported with two periodicity values and a same offset value; where a first periodicity value corresponding to the first submatrix is an integer multiple of a second periodicity value corresponding to the second submatrix; where the set of channel measurement resources comprises multiple NZP CSI-RS resources; where the first submatrix comprises a first set of parameters that are common for the multiple NZP CSI-RS resources, the second submatrix is decomposed into multiple partitions, and each partition of the multiple partitions is associated with each NZP CSI-RS resource of the multiple NZP CSI-RS resources; where the multiple NZP CSI-RS resources are partitioned into two subsets of NZP CSI-RS resources, each NZP CSI-RS resource of a first subset of the NZP CSI-RS resources is associated with a number of NZP CSI-RS ports that is equal to a number of dimensions of the precoding matrix, and each NZP CSI-RS resource of a second subset of the NZP CSI-RS resources is associated with a number of NZP CSI-RS ports that is equal to a number of dimensions of the first submatrix; where the first subset of the NZP CSI-RS resources comprises a single NZP CSI-RS resource, and the second subset of the NZP CSI-RS resources comprises a remainder of NZP CSI-RS resources of the multiple NZP CSI-RS resources; where the CSI report includes a single value of the first submatrix and multiple values of the second submatrix, and each value of the multiple values of the second submatrix is associated with each NZP CSI-RS resource of the multiple NZP CSI-RS resources.

For example, the processor 1304 may support wireless communication at the device 1302 in accordance with examples as disclosed herein. Processor 1304 may be configured as or otherwise support a means for receiving, from a network entity, a first signaling indicating a CSI reporting setting; receiving, from the network entity, a set of channel measurement resources including at least one NZP CSI-RS resource; generating, based on the at least one NZP CSI-RS resource and the CSI reporting setting, a precoding matrix that is associated with a CSI report, where the precoding matrix comprises a Kronecker product of a first submatrix and a second submatrix; and transmitting, to the network entity, a second signaling indicating the CSI report.

Additionally or alternatively, the processor 1304 may be configured to or otherwise support: where the Kronecker product of the first submatrix and the second submatrix corresponds to a matrix having dimensions that are a product of dimensions of the first submatrix and the second submatrix; where the first submatrix and the second submatrix correspond to different resolutions of the precoding matrix in at least one of spatial domain, beam domain, frequency domain, delay domain, time domain or Doppler domain; where a number of dimensions of the first submatrix is equal to a number of antenna ports of a first antenna group of two antenna port groups, and a number of dimensions of the second submatrix is equal to a number of antenna ports of a second antenna group of the two antenna port groups; where the first antenna group and the second antenna group correspond to at least one of: two sets of CSI-RS port groups; two antenna port groups with horizontal and vertical orientations, respectively; or two sets of spatial beams; generating, in a first mode, the precoding matrix using the Kronecker product of the first submatrix and the second submatrix, and generating, in a second mode, the precoding matrix using the first submatrix; where the CSI report includes two channel quality indicator (CQI) values, a first CQI value corresponds to the first mode and a second CQI value corresponds to the second mode; where the at least one NZP CSI-RS resource comprises two groups of NZP CSI-RS ports; where at least one of: the two groups of NZP CSI-RS ports correspond to two distinct NZP CSI-RS resources; the two groups of NZP CSI-RS ports are configured with a same time offset value; the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or the two groups of NZP CSI-RS ports are configured with two frequency density values, a first frequency density value corresponding to the first group of NZP CSI-RS ports is an integer multiple of a second frequency density value corresponding to the second group of NZP CSI-RS ports; where the first submatrix comprises a set of pre-defined vectors associated with one or more indicator values, and the second submatrix comprises a set of coefficients, where each coefficient of the set of coefficients comprises an amplitude value and a phase value; where the CSI reporting setting configures an apparatus implementing the method with one of periodic CSI reporting or semi-persistent CSI reporting, the first submatrix and the second submatrix being reported with two periodicity values and a same offset value; where a first periodicity value corresponding to the first submatrix is an integer multiple of a second periodicity value corresponding to the second submatrix; where the set of channel measurement resources comprises multiple NZP CSI-RS resources; where the first submatrix comprises a first set of parameters that are common for the multiple NZP CSI-RS resources, the second submatrix is decomposed into multiple partitions, and each partition of the multiple partitions is associated with each NZP CSI-RS resource of the multiple NZP CSI-RS resources; where the multiple NZP CSI-RS resources are partitioned into two subsets of NZP CSI-RS resources, each NZP CSI-RS resource of a first subset of the NZP CSI-RS resources is associated with a number of NZP CSI-RS ports that is equal to a number of dimensions of the precoding matrix, and each NZP CSI-RS resource of a second subset of the NZP CSI-RS resources is associated with a number of NZP CSI-RS ports that is equal to a number of dimensions of the first submatrix; where the first subset of the NZP CSI-RS resources comprises a single NZP CSI-RS resource, and the second subset of the NZP CSI-RS resources comprises a remainder of NZP CSI-RS resources of the multiple NZP CSI-RS resources; where the CSI report includes a single value of the first submatrix and multiple values of the second submatrix, and each value of the multiple values of the second submatrix is associated with each NZP CSI-RS resource of the multiple NZP CSI-RS resources.

The processor 1304 of the device 1302, such as a UE 104, may support wireless communication in accordance with examples as disclosed herein. The processor 1304 includes at least one controller coupled with at least one memory, and is configured to or operable to cause the processor to receive, from a network entity, a first signaling indicating a CSI reporting setting; receive, from the network entity, a set of channel measurement resources comprising at least one NZP CSI-RS resource; generate, based on the at least one NZP CSI-RS resource and the CSI reporting setting, a precoding matrix that is associated with a CSI report, wherein the precoding matrix comprises a Kronecker product of a first submatrix and a second submatrix; transmit, to the network entity, a second signaling indicating the CSI report.

The processor 1304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1304 may be configured to operate a memory array using a memory controller. In some other implementations, a memory controller may be integrated into the processor 1304. The processor 1304 may be configured to execute computer-readable instructions stored in a memory (e.g., the memory 1306) to cause the device 1302 to perform various functions of the present disclosure.

The memory 1306 may include random access memory (RAM) and read-only memory (ROM). The memory 1306 may store computer-readable, computer-executable code including instructions that, when executed by the processor 1304 cause the device 1302 to perform various functions described herein. The code may be stored in a non-transitory computer-readable medium such as system memory or another type of memory. In some implementations, the code may not be directly executable by the processor 1304 but may cause a computer (e.g., when compiled and executed) to perform functions described herein. In some implementations, the memory 1306 may include, among other things, a basic I/O system (BIOS) which may control basic hardware or software operation such as the interaction with peripheral components or devices.

The I/O controller 1310 may manage input and output signals for the device 1302. The I/O controller 1310 may also manage peripherals not integrated into the device 1302. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. In some implementations, the I/O controller 1310 may be implemented as part of a processor, such as the processor 1304. In some implementations, a user may interact with the device 1302 via the I/O controller 1310 or via hardware components controlled by the I/O controller 1310.

In some implementations, the device 1302 may include a single antenna 1312. However, in some other implementations, the device 1302 may have more than one antenna 1312 (i.e., multiple antennas), including multiple antenna panels or antenna arrays, which may be capable of concurrently transmitting or receiving multiple wireless transmissions. The transceiver 1308 may communicate bi-directionally, via the one or more antennas 1312, wired, or wireless links as described herein. For example, the transceiver 1308 may represent a wireless transceiver and may communicate bi-directionally with another wireless transceiver. The transceiver 1308 may also include a modem to modulate the packets, to provide the modulated packets to one or more antennas 1312 for transmission, and to demodulate packets received from the one or more antennas 1312.

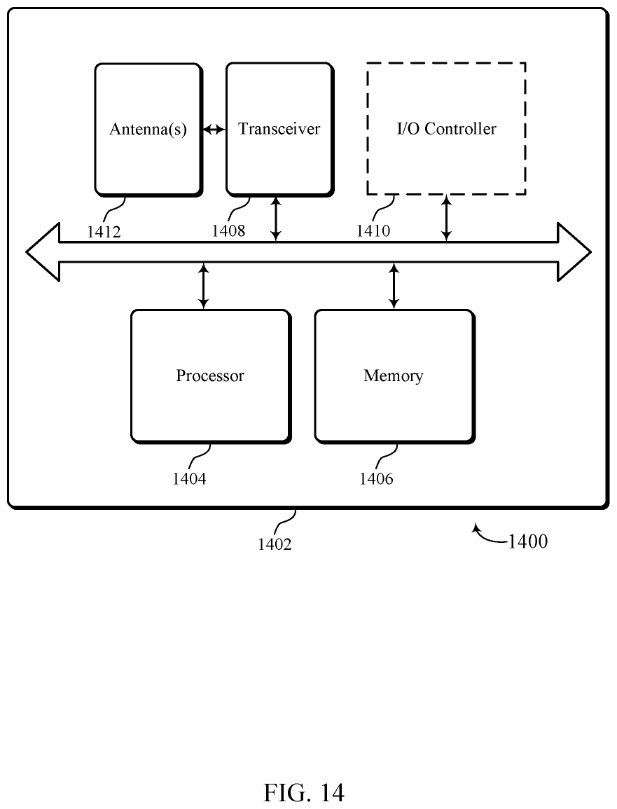

FIG. 14 illustrates an example of a block diagram 1400 of a device 1402 that supports multi-resolution precoding based on multiple submatrices in accordance with aspects of the present disclosure. The device 1402 may be an example of a network entity 102 as described herein. The device 1402 may support wireless communication with one or more network entities 102, UEs 104, or any combination thereof. The device 1402 may include components for bi-directional communications including components for transmitting and receiving communications, such as a processor 1404, a memory 1406, a transceiver 1408, and an I/O controller 1410. These components may be in electronic communication or otherwise coupled (e.g., operatively, communicatively, functionally, electronically, electrically) via one or more interfaces (e.g., buses). The device 1402 may also be referred to as an apparatus.

The processor 1404, the memory 1406, the transceiver 1408, or various combinations thereof or various components thereof may be examples of means for performing various aspects of the present disclosure as described herein. For example, the processor 1404, the memory 1406, the transceiver 1408, or various combinations or components thereof may support a method for performing one or more of the operations described herein.

In some implementations, the processor 1404, the memory 1406, the transceiver 1408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1404 and the memory 1406 coupled with the processor 1404 may be configured to perform one or more of the functions described herein (e.g., executing, by the processor 1404, instructions stored in the memory 1406).

For example, the processor 1404 may support wireless communication at the device 1402 in accordance with examples as disclosed herein. Processor 1404 may be configured as or otherwise support to: transmit, to a UE, a first signaling indicating a CSI reporting setting; transmit, to the UE, a set of channel measurement resources including at least one NZP CSI-RS resource; receive, from the UE, a second signaling indicating a CSI report associated with a precoding matrix generated based on the at least one NZP CSI-RS resource and the CSI reporting setting, where the precoding matrix comprises a Kronecker product of a first submatrix and a second submatrix.

Additionally or alternatively, the processor 1404 may be configured to or otherwise support: where the Kronecker product of the first submatrix and the second submatrix corresponds to a matrix having dimensions that are a product of dimensions of the first submatrix and the second submatrix; where the first submatrix and the second submatrix correspond to different resolutions of the precoding matrix in at least one of spatial domain, beam domain, frequency domain, delay domain, time domain or Doppler domain; where a number of dimensions of the first submatrix is equal to a number of antenna ports of a first antenna group of two antenna port groups, and a number of dimensions of the second submatrix is equal to a number of antenna ports of a second antenna group of the two antenna port groups; where the first antenna group and the second antenna group correspond to at least one of: two sets of CSI-RS port groups; two antenna port groups with horizontal and vertical orientations, respectively; or two sets of spatial beams; the precoding matrix having been generated, in a first mode, using the Kronecker product of the first submatrix and the second submatrix, and generated, in a second mode, using the first submatrix; where the CSI report includes two channel quality indicator (CQI) values, a first CQI value corresponds to the first mode and a second CQI value corresponds to the second mode; where the at least one NZP CSI-RS resource comprises two groups of NZP CSI-RS ports; where at least one of: the two groups of NZP CSI-RS ports correspond to two distinct NZP CSI-RS resources; the two groups of NZP CSI-RS ports are configured with a same time offset value; the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or the two groups of NZP CSI-RS ports are configured with two frequency density values, a first frequency density value corresponding to the first group of NZP CSI-RS ports is an integer multiple of a second frequency density value corresponding to the second group of NZP CSI-RS ports; where the first submatrix comprises a set of pre-defined vectors associated with one or more indicator values, and the second submatrix comprises a set of coefficients, where each coefficient of the set of coefficients comprises an amplitude value and a phase value; where the CSI reporting setting configures the UE with one of periodic CSI reporting or semi-persistent CSI reporting, the first submatrix and the second submatrix being reported with two periodicity values and a same offset value; where a first periodicity value corresponding to the first submatrix is an integer multiple of a second periodicity value corresponding to the second submatrix; where the set of channel measurement resources comprises multiple NZP CSI-RS resources; where the first submatrix comprises a first set of parameters that are common for the multiple NZP CSI-RS resources, the second submatrix is decomposed into multiple partitions, and each partition of the multiple partitions is associated with each NZP CSI-RS resource of the multiple NZP CSI-RS resources; where the multiple NZP CSI-RS resources are partitioned into two subsets of NZP CSI-RS resources, each NZP CSI-RS resource of a first subset of the NZP CSI-RS resources is associated with a number of NZP CSI-RS ports that is equal to a number of dimensions of the precoding matrix, and each NZP CSI-RS resource of a second subset of the NZP CSI-RS resources is associated with a number of NZP CSI-RS ports that is equal to a number of dimensions of the first submatrix; where the first subset of the NZP CSI-RS resources comprises a single NZP CSI-RS resource, and the second subset of the NZP CSI-RS resources comprises a remainder of NZP CSI-RS resources of the multiple NZP CSI-RS resources; where the CSI report includes a single value of the first submatrix and multiple values of the second submatrix, and each value of the multiple values of the second submatrix is associated with each NZP CSI-RS resource of the multiple NZP CSI-RS resources.

For example, the processor 1404 may support wireless communication at the device 1402 in accordance with examples as disclosed herein. Processor 1404 may be configured as or otherwise support a means for transmitting, to a UE, a first signaling indicating a CSI reporting setting; transmitting, to the UE, a set of channel measurement resources including at least one NZP CSI-RS resource; and receiving, from the UE, a second signaling indicating a CSI report associated with a precoding matrix generated based on the at least one NZP CSI-RS resource and the CSI reporting setting, where the precoding matrix comprises a Kronecker product of a first submatrix and a second submatrix.

Additionally or alternatively, the processor 1404 may be configured to or otherwise support: where the Kronecker product of the first submatrix and the second submatrix corresponds to a matrix having dimensions that are a product of dimensions of the first submatrix and the second submatrix; where the first submatrix and the second submatrix correspond to different resolutions of the precoding matrix in at least one of spatial domain, beam domain, frequency domain, delay domain, time domain or Doppler domain; where a number of dimensions of the first submatrix is equal to a number of antenna ports of a first antenna group of two antenna port groups, and a number of dimensions of the second submatrix is equal to a number of antenna ports of a second antenna group of the two antenna port groups; where the first antenna group and the second antenna group correspond to at least one of: two sets of CSI-RS port groups; two antenna port groups with horizontal and vertical orientations, respectively; or two sets of spatial beams; the precoding matrix having been generated, in a first mode, using the Kronecker product of the first submatrix and the second submatrix, and generated, in a second mode, using the first submatrix; where the CSI report includes two CQI values, a first CQI value corresponds to the first mode and a second CQI value corresponds to the second mode; where the at least one NZP CSI-RS resource comprises two groups of NZP CSI-RS ports; where at least one of: the two groups of NZP CSI-RS ports correspond to two distinct NZP CSI-RS resources; the two groups of NZP CSI-RS ports are configured with a same time offset value; the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or the two groups of NZP CSI-RS ports are configured with two frequency density values, a first frequency density value corresponding to the first group of NZP CSI-RS ports is an integer multiple of a second frequency density value corresponding to the second group of NZP CSI-RS ports; where the first submatrix comprises a set of pre-defined vectors associated with one or more indicator values, and the second submatrix comprises a set of coefficients, where each coefficient of the set of coefficients comprises an amplitude value and a phase value; where the CSI reporting setting configures the UE with one of periodic CSI reporting or semi-persistent CSI reporting, the first submatrix and the second submatrix being reported with two periodicity values and a same offset value; where a first periodicity value corresponding to the first submatrix is an integer multiple of a second periodicity value corresponding to the second submatrix; where the set of channel measurement resources comprises multiple NZP CSI-RS resources; where the first submatrix comprises a first set of parameters that are common for the multiple NZP CSI-RS resources, the second submatrix is decomposed into multiple partitions, and each partition of the multiple partitions is associated with each NZP CSI-RS resource of the multiple NZP CSI-RS resources; where the multiple NZP CSI-RS resources are partitioned into two subsets of NZP CSI-RS resources, each NZP CSI-RS resource of a first subset of the NZP CSI-RS resources is associated with a number of NZP CSI-RS ports that is equal to a number of dimensions of the precoding matrix, and each NZP CSI-RS resource of a second subset of the NZP CSI-RS resources is associated with a number of NZP CSI-RS ports that is equal to a number of dimensions of the first submatrix; where the first subset of the NZP CSI-RS resources comprises a single NZP CSI-RS resource, and the second subset of the NZP CSI-RS resources comprises a remainder of NZP CSI-RS resources of the multiple NZP CSI-RS resources; where the CSI report includes a single value of the first submatrix and multiple values of the second submatrix, and each value of the multiple values of the second submatrix is associated with each NZP CSI-RS resource of the multiple NZP CSI-RS resources.

The processor 1404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1404 may be configured to operate a memory array using a memory controller. In some other implementations, a memory controller may be integrated into the processor 1404. The processor 1404 may be configured to execute computer-readable instructions stored in a memory (e.g., the memory 1406) to cause the device 1402 to perform various functions of the present disclosure.

The memory 1406 may include random access memory (RAM) and read-only memory (ROM). The memory 1406 may store computer-readable, computer-executable code including instructions that, when executed by the processor 1404 cause the device 1402 to perform various functions described herein. The code may be stored in a non-transitory computer-readable medium such as system memory or another type of memory. In some implementations, the code may not be directly executable by the processor 1404 but may cause a computer (e.g., when compiled and executed) to perform functions described herein. In some implementations, the memory 1406 may include, among other things, a basic I/O system (BIOS) which may control basic hardware or software operation such as the interaction with peripheral components or devices.

The I/O controller 1410 may manage input and output signals for the device 1402. The I/O controller 1410 may also manage peripherals not integrated into the device 1402. In some implementations, the I/O controller 1410 may represent a physical connection or port to an external peripheral. In some implementations, the I/O controller 1410 may utilize an operating system such as iOS®, ANDROID®, MS-DOS®, MS-WINDOWS®, OS/2®, UNIX®, LINUX®, or another known operating system. In some implementations, the I/O controller 1410 may be implemented as part of a processor, such as the processor 1404. In some implementations, a user may interact with the device 1402 via the I/O controller 1410 or via hardware components controlled by the I/O controller 1410.

In some implementations, the device 1402 may include a single antenna 1412. However, in some other implementations, the device 1402 may have more than one antenna 1412 (i.e., multiple antennas), including multiple antenna panels or antenna arrays, which may be capable of concurrently transmitting or receiving multiple wireless transmissions. The transceiver 1408 may communicate bi-directionally, via the one or more antennas 1412, wired, or wireless links as described herein. For example, the transceiver 1408 may represent a wireless transceiver and may communicate bi-directionally with another wireless transceiver. The transceiver 1408 may also include a modem to modulate the packets, to provide the modulated packets to one or more antennas 1412 for transmission, and to demodulate packets received from the one or more antennas 1412.

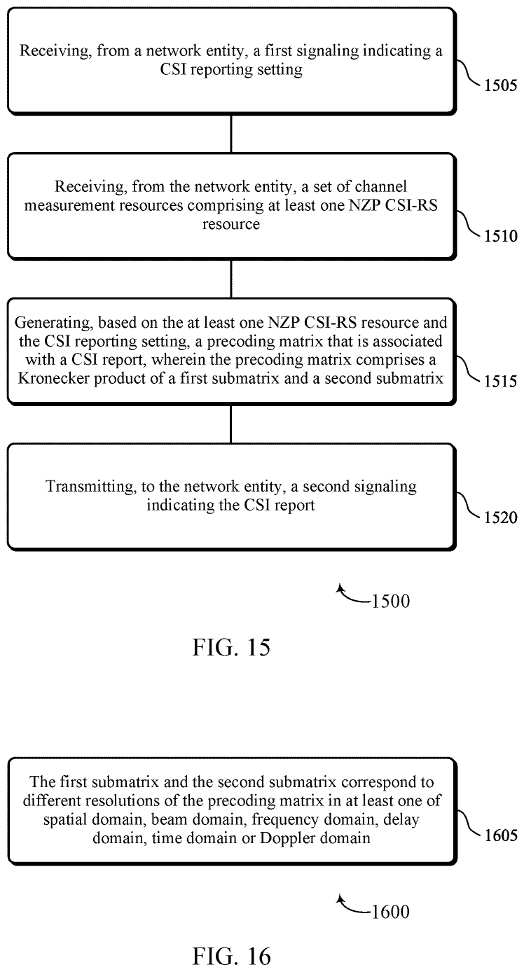

FIG. 15 illustrates a flowchart of a method 1500 that supports multi-resolution precoding based on multiple submatrices in accordance with aspects of the present disclosure. The operations of the method 1500 may be implemented by a device or its components as described herein. For example, the operations of the method 1500 may be performed by UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1505, the method may include receiving, from a network entity, a first signaling indicating a CSI reporting setting. The operations of 1505 may be performed in accordance with examples as described herein. In some implementations, aspects of the operations of 1505 may be performed by a device as described with reference to FIG. 1.

At 1510, the method may include receiving, from the network entity, a set of channel measurement resources comprising at least one NZP CSI-RS resource. The operations of 1510 may be performed in accordance with examples as described herein. In some implementations, aspects of the operations of 1510 may be performed by a device as described with reference to FIG. 1.

At 1515, the method may include generating, based on the at least one NZP CSI-RS resource and the CSI reporting setting, a precoding matrix that is associated with a CSI report, wherein the precoding matrix comprises a Kronecker product of a first submatrix and a second submatrix. The operations of 1515 may be performed in accordance with examples as described herein. In some implementations, aspects of the operations of 1515 may be performed by a device as described with reference to FIG. 1.

At 1520, the method may include transmitting, to the network entity, a second signaling indicating the CSI report. The operations of 1520 may be performed in accordance with examples as described herein. In some implementations, aspects of the operations of 1520 may be performed by a device as described with reference to FIG. 1.

FIG. 16 illustrates a flowchart of a method 1600 that supports multi-resolution precoding based on multiple submatrices in accordance with aspects of the present disclosure. The operations of the method 1600 may be implemented by a device or its components as described herein. For example, the operations of the method 1600 may be performed by UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1605, the method may include the first submatrix and the second submatrix correspond to different resolutions of the precoding matrix in at least one of spatial domain, beam domain, frequency domain, delay domain, time domain or Doppler domain. The operations of 1605 may be performed in accordance with examples as described herein. In some implementations, aspects of the operations of 1605 may be performed by a device as described with reference to FIG. 1.

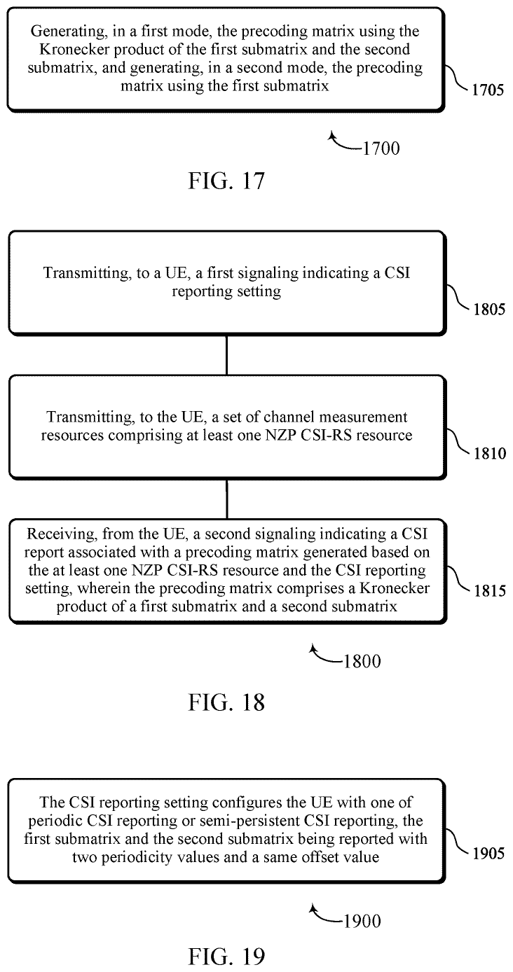

FIG. 17 illustrates a flowchart of a method 1700 that supports multi-resolution precoding based on multiple submatrices in accordance with aspects of the present disclosure. The operations of the method 1700 may be implemented by a device or its components as described herein. For example, the operations of the method 1700 may be performed by UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1705, the method may include generating, in a first mode, the precoding matrix using the Kronecker product of the first submatrix and the second submatrix, and generating, in a second mode, the precoding matrix using the first submatrix. The operations of 1705 may be performed in accordance with examples as described herein. In some implementations, aspects of the operations of 1705 may be performed by a device as described with reference to FIG. 1.

FIG. 18 illustrates a flowchart of a method 1800 that supports multi-resolution precoding based on multiple submatrices in accordance with aspects of the present disclosure. The operations of the method 1800 may be implemented by a device or its components as described herein. For example, the operations of the method 1800 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1805, the method may include transmitting, to a UE, a first signaling indicating a CSI reporting setting. The operations of 1805 may be performed in accordance with examples as described herein. In some implementations, aspects of the operations of 1805 may be performed by a device as described with reference to FIG. 1.

At 1810, the method may include transmitting, to the UE, a set of channel measurement resources comprising at least one NZP CSI-RS resource. The operations of 1810 may be performed in accordance with examples as described herein. In some implementations, aspects of the operations of 1810 may be performed by a device as described with reference to FIG. 1.

At 1815, the method may include receiving, from the UE, a second signaling indicating a CSI report associated with a precoding matrix generated based on the at least one NZP CSI-RS resource and the CSI reporting setting, wherein the precoding matrix comprises a Kronecker product of a first submatrix and a second submatrix. The operations of 1815 may be performed in accordance with examples as described herein. In some implementations, aspects of the operations of 1815 may be performed by a device as described with reference to FIG. 1.

FIG. 19 illustrates a flowchart of a method 1900 that supports multi-resolution precoding based on multiple submatrices in accordance with aspects of the present disclosure. The operations of the method 1900 may be implemented by a device or its components as described herein. For example, the operations of the method 1900 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1905, the method may include the CSI reporting setting configures the UE with one of periodic CSI reporting or semi-persistent CSI reporting, the first submatrix and the second submatrix being reported with two periodicity values and a same offset value. The operations of 1905 may be performed in accordance with examples as described herein. In some implementations, aspects of the operations of 1905 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a channel state information (CSI) reporting setting;
receive a set of channel measurement resources comprising at least one non-zero power (NZP) CSI reference signal (CSI-RS) resource;
generate, based at least in part on the at least one NZP CSI-RS resource and the CSI reporting setting, a precoding matrix that is associated with a CSI report, wherein the precoding matrix comprises a Kronecker product of a first submatrix and a second submatrix;
transmit, a second signaling indicating the CSI report.

2. The UE of claim 1, wherein the Kronecker product of the first submatrix and the second submatrix corresponds to a matrix having dimensions that are a product of dimensions of the first submatrix and the second submatrix.

3. The UE of claim 1, wherein the first submatrix and the second submatrix correspond to different resolutions of the precoding matrix in at least one of spatial domain, beam domain, frequency domain, delay domain, time domain or Doppler domain.

4. The UE of claim 3, wherein a number of dimensions of the first submatrix is equal to a number of antenna ports of a first antenna group of two antenna port groups, and a number of dimensions of the second submatrix is equal to a number of antenna ports of a second antenna group of the two antenna port groups.

5. The UE of claim 4, wherein the first antenna group and the second antenna group correspond to at least one of:
two sets of CSI-RS port groups;
two antenna port groups with horizontal and vertical orientations, respectively; or
two sets of spatial beams.

6. The UE of claim 1, wherein the at least one processor is further operable to cause the UE to generate, in a first mode, the precoding matrix using the Kronecker product of the first submatrix and the second submatrix, and generate, in a second mode, the precoding matrix using the first submatrix.

7. The UE of claim 6, wherein the CSI report includes two channel quality indicator (CQI) values, and wherein a first CQI value corresponds to the first mode and a second CQI value corresponds to the second mode.

8. The UE of claim 1, wherein the at least one NZP CSI-RS resource comprises two groups of NZP CSI-RS ports.

9. The UE of claim 8, wherein at least one of:
the two groups of NZP CSI-RS ports correspond to two distinct NZP CSI-RS resources;
the two groups of NZP CSI-RS ports are configured with a same time offset value;
the two groups of NZP CSI-RS ports are configured with two periodicity values, a first periodicity value corresponding to a first group of NZP CSI-RS ports is an integer multiple of a second periodicity value corresponding to a second group of NZP CSI-RS ports; or
the two groups of NZP CSI-RS ports are configured with two frequency density values, a first frequency density value corresponding to the first group of NZP CSI-RS ports is an integer multiple of a second frequency density value corresponding to the second group of NZP CSI-RS ports.

10. The UE of claim 1, wherein the first submatrix comprises a set of pre-defined vectors associated with one or more indicator values, wherein the second submatrix comprises a set of coefficients, and wherein each coefficient of the set of coefficients comprises an amplitude value and a phase value.

11. The UE of claim 1, wherein the CSI reporting setting configures the UE with one of periodic CSI reporting or semi-persistent CSI reporting, and wherein the first submatrix and the second submatrix are reported with two periodicity values and a same offset value.

12. The UE of claim 11, wherein a first periodicity value corresponding to the first submatrix is an integer multiple of a second periodicity value corresponding to the second submatrix.

13. The UE of claim 1, wherein the set of channel measurement resources comprises multiple NZP CSI-RS resources.

14. The UE of claim 13, wherein the first submatrix comprises a first set of parameters that are common for the multiple NZP CSI-RS resources, wherein the second submatrix is decomposed into multiple partitions, and wherein each partition of the multiple partitions is associated with each NZP CSI-RS resource of the multiple NZP CSI-RS resources.

15. The UE of claim 13, wherein the multiple NZP CSI-RS resources are partitioned into two subsets of NZP CSI-RS resources, wherein each NZP CSI-RS resource of a first subset of the NZP CSI-RS resources is associated with a number of NZP CSI-RS ports that is equal to a number of dimensions of the precoding matrix, and wherein each NZP CSI-RS resource of a second subset of the NZP CSI-RS resources is associated with a number of NZP CSI-RS ports that is equal to a number of dimensions of the first submatrix.

16. The UE of claim 15, wherein the first subset of the NZP CSI-RS resources comprises a single NZP CSI-RS resource, and wherein the second subset of the NZP CSI-RS resources comprises a remainder of NZP CSI-RS resources of the multiple NZP CSI-RS resources.

17. The UE of claim 13, wherein the CSI report includes a single value of the first submatrix and multiple values of the second submatrix, and wherein each value of the multiple values of the second submatrix is associated with each NZP CSI-RS resource of the multiple NZP CSI-RS resources.

18. A network entity (NE) for wireless communication, comprising:
at least one memory; and
at least one processor coupled with the at least one memory and operable to cause the NE to:
transmit a channel state information (CSI) reporting setting;
transmit a set of channel measurement resources comprising at least one non-zero power (NZP) CSI reference signal (CSI-RS) resource;
receive a CSI report associated with a precoding matrix generated based at least in part on the at least one NZP CSI-RS resource and the CSI reporting setting, wherein the precoding matrix comprises a Kronecker product of a first submatrix and a second submatrix.

19. A method performed by a user equipment (UE), the method comprising:
receiving entity, a first signaling indicating a channel state information (CSI) reporting setting;
receiving a set of channel measurement resources comprising at least one non-zero power (NZP) CSI reference signal (CSI-RS) resource;
generating, based at least in part on the at least one NZP CSI-RS resource and the CSI reporting setting, a precoding matrix that is associated with a CSI report, wherein the precoding matrix comprises a Kronecker product of a first submatrix and a second submatrix; and
transmitting a second signaling indicating the CSI report.

20. (canceled)

21. A method performed by a network entity (NE), the method comprising:
transmitting a channel state information (CSI) reporting setting;
transmitting a set of channel measurement resources comprising at least one non-zero power (NZP) CSI reference signal (CSI-RS) resource;
receiving a CSI report associated with a precoding matrix generated based at least in part on the at least one NZP CSI-RS resource and the CSI reporting setting, wherein the precoding matrix comprises a Kronecker product of a first submatrix and a second submatrix.
